(19) United States
(12) Patent Application Publication
(10) Pub. No.: US 2018/0356614 A1
(43) Pub. Date: Dec. 13, 2018

(54) OPTICAL IMAGING LENS ASSEMBLY, IMAGE CAPTURING UNIT AND ELECTRONIC DEVICE

(71) Applicant: LARGAN Precision Co., Ltd., Taichung City (TW)

(72) Inventors: Chun-Che HSUEH, Taichung City (TW); Tzu-Chieh KUO, Taichung City (TW)

(21) Appl. No.: 15/653,204

(22) Filed: Jul. 18, 2017

(30) Foreign Application Priority Data
Jun. 9, 2017 (TW) 106119360

(51) Int. Cl. G02B 13/00; G02B 1/00

(52) U.S. Cl. CPC G02B 13/0045; G02B 13/18; G02B 1/007; G02B 13/001

(57) ABSTRACT

An optical imaging lens assembly includes, in order from an object side to an image side: a first lens element, a second lens element, a third lens element, a fourth lens element, a fifth lens element and a sixth lens element. The second lens element has positive refractive power. The third lens element has negative refractive power. The fifth lens element has positive refractive power. The sixth lens element has negative refractive power. At least one surface among object-side surfaces and image-side surfaces of the six lens elements of the optical imaging lens assembly has at least one critical point in an off-axial region thereof and is aspheric.

### RELATED APPLICATIONS

This application claims priority to Taiwan Application 106119360, filed Jun. 9, 2017, which is incorporated by reference herein in its entirety.

### BACKGROUND

### Technical Field

The present disclosure relates to an optical imaging lens assembly, an image capturing unit and an electronic device, more particularly to an optical imaging lens assembly and an image capturing unit applicable to an electronic device.

### Description of Related Art

In recent years, with the popularity of electronic devices having camera functionalities, the demand of miniaturized optical systems has been increasing. As the advanced semiconductor manufacturing technologies have reduced the pixel size of sensors, and compact optical systems have gradually evolved toward the field of higher megapixels, there is an increasing demand for compact optical systems featuring better image quality.

For various applications, the optical systems have been widely applied to different kinds of electronic devices, such as vehicle devices, image recognition systems, entertainment devices, sport devices and intelligent home assistance systems. In order to capture enough image information in low light condition (for example, in the night) or dynamic photography, the optical systems usually have a large aperture. However, portable electronic devices are, in general, small in size, such that it is difficult for the optical systems disposed in the portable electronic devices to meet the requirement of having a large aperture while maintaining wide field of view. Therefore, there is a need to develop a compact optical system featuring large aperture and wide field of view.

### SUMMARY

According to one aspect of the present disclosure, an optical imaging lens assembly includes six lens elements. The six lens elements are, in order from an object side to an image side, a first lens element, a second lens element, a third lens element, a fourth lens element, a fifth lens element and a sixth lens element. The second lens element has positive refractive power. The third lens element has negative refractive power. The fifth lens element with positive refractive power has an image-side surface being convex in a paraxial region thereof. The sixth lens element has negative refractive power. At least one surface among object-side surfaces and image-side surfaces of the six lens elements has at least one critical point in an off-axial region thereof and is aspheric. When an Abbe number of the sixth lens element is V6, an axial distance between the first lens element and the second lens element is T12, an axial distance between the second lens element and the third lens element is T23, an axial distance between the third lens element and the fourth lens element is T34, an axial distance between the fourth lens element and the fifth lens element is T45, an axial distance between the fifth lens element and the sixth lens element is T56, an axial distance between an object-side surface of the first lens element and an image-side surface of the sixth lens element is TD, and an entrance pupil diameter of the optical imaging lens assembly is EPD, the following conditions are satisfied:

V6<41;

1.5<(T34+T45)/(T12+T23+T56)<50; and

0.8<TD/EPD<2.5.

According to another aspect of the present disclosure, an optical imaging lens assembly includes six lens elements. The six lens elements are, in order from an object side to an image side, a first lens element, a second lens element, a third lens element, a fourth lens element, a fifth lens element and a sixth lens element. The second lens element has positive refractive power. The third lens element has negative refractive power. The fourth lens element has an object-side surface being convex in a paraxial region thereof. The fifth lens element with positive refractive power has an object-side surface being concave in a paraxial region thereof and an image-side surface being convex in a paraxial region thereof. The sixth lens element has negative refractive power. At least one surface among object-side surfaces and image-side surfaces of the six lens elements has at least one critical point in an off-axial region thereof and is aspheric. When an Abbe number of the sixth lens element is V6, an axial distance between the first lens element and the second lens element is T12, an axial distance between the second lens element and the third lens element is T23, an axial distance between the third lens element and the fourth lens element is T34, an axial distance between the fourth lens element and the fifth lens element is T45, and an axial distance between the fifth lens element and the sixth lens element is T56, the following conditions are satisfied:

V6<41; and

2.3<(T34+T45)/(T12+T23+T56)<30.

According to still another aspect of the present disclosure, an optical imaging lens assembly includes six lens elements. The six lens elements are, in order from an object side to an image side, a first lens element, a second lens element, a third lens element, a fourth lens element, a fifth lens element and a sixth lens element. The first lens element has negative refractive power. The second lens element has positive refractive power. The third lens element has negative refractive power. The fifth lens element has positive refractive power. The sixth lens element has negative refractive power. At least one surface among object-side surfaces and image-side surfaces of the six lens elements has at least one critical point in an off-axial region thereof and is aspheric. When an Abbe number of the sixth lens element is V6, an axial distance between an object-side surface of the first lens element and an image-side surface of the sixth lens element is TD, and an entrance pupil diameter of the optical imaging lens assembly is EPD, the following conditions are satisfied:

V6<41; and

0.8<TD/EPD<2.5.

According to yet another aspect of the present disclosure, an image capturing unit includes the aforementioned optical imaging lens assembly and an image sensor, wherein the image sensor is disposed on an image surface of the optical imaging lens assembly.

According to yet still another aspect of the present disclosure, an electronic device includes the aforementioned image capturing unit.

### BRIEF DESCRIPTION OF THE DRAWINGS

The disclosure can be better understood by reading the following detailed description of the embodiments, with reference made to the accompanying drawings as follows:

FIG. 1 is a schematic view of an image capturing unit according to the 1st embodiment of the present disclosure;

FIG. 2 shows spherical aberration curves, astigmatic field curves and a distortion curve of the image capturing unit according to the 1st embodiment;

FIG. 3 is a schematic view of an image capturing unit according to the 2nd embodiment of the present disclosure;

FIG. 4 shows spherical aberration curves, astigmatic field curves and a distortion curve of the image capturing unit according to the 2nd embodiment;

FIG. 5 is a schematic view of an image capturing unit according to the 3rd embodiment of the present disclosure;

FIG. 6 shows spherical aberration curves, astigmatic field curves and a distortion curve of the image capturing unit according to the 3rd embodiment;

FIG. 7 is a schematic view of an image capturing unit according to the 4th embodiment of the present disclosure;

FIG. 8 shows spherical aberration curves, astigmatic field curves and a distortion curve of the image capturing unit according to the 4th embodiment;

FIG. 9 is a schematic view of an image capturing unit according to the 5th embodiment of the present disclosure;

FIG. 10 shows spherical aberration curves, astigmatic field curves and a distortion curve of the image capturing unit according to the 5th embodiment;

FIG. 11 is a schematic view of an image capturing unit according to the 6th embodiment of the present disclosure;

FIG. 12 shows spherical aberration curves, astigmatic field curves and a distortion curve of the image capturing unit according to the 6th embodiment;

FIG. 13 is a schematic view of an image capturing unit according to the 7th embodiment of the present disclosure;

FIG. 14 shows spherical aberration curves, astigmatic field curves and a distortion curve of the image capturing unit according to the 7th embodiment;

FIG. 15 is a schematic view of an image capturing unit according to the 8th embodiment of the present disclosure;

FIG. 16 shows spherical aberration curves, astigmatic field curves and a distortion curve of the image capturing unit according to the 8th embodiment;

FIG. 17 is a schematic view of an image capturing unit according to the 9th embodiment of the present disclosure;

FIG. 18 shows spherical aberration curves, astigmatic field curves and a distortion curve of the image capturing unit according to the 9th embodiment;

FIG. 19 is a schematic view of an image capturing unit according to the 10th embodiment of the present disclosure;

FIG. 20 shows spherical aberration curves, astigmatic field curves and a distortion curve of the image capturing unit according to the 10th embodiment;

FIG. 21 is a perspective view of an image capturing unit according to the 11th embodiment of the present disclosure;

FIG. 22 is one perspective view of an electronic device according to the 12th embodiment of the present disclosure;

FIG. 23 is another perspective view of the electronic device in FIG. 22;

FIG. 24 is a block diagram of the electronic device in FIG. 22; and

FIG. 25 shows a schematic view of Y11, Y62 and critical points on each lens element, according to the 1st embodiment of the present disclosure.

### DETAILED DESCRIPTION

An optical imaging lens assembly includes, in order from an object side to an image side, a first lens element, a second lens element, a third lens element, a fourth lens element, a fifth lens element and a sixth lens element.

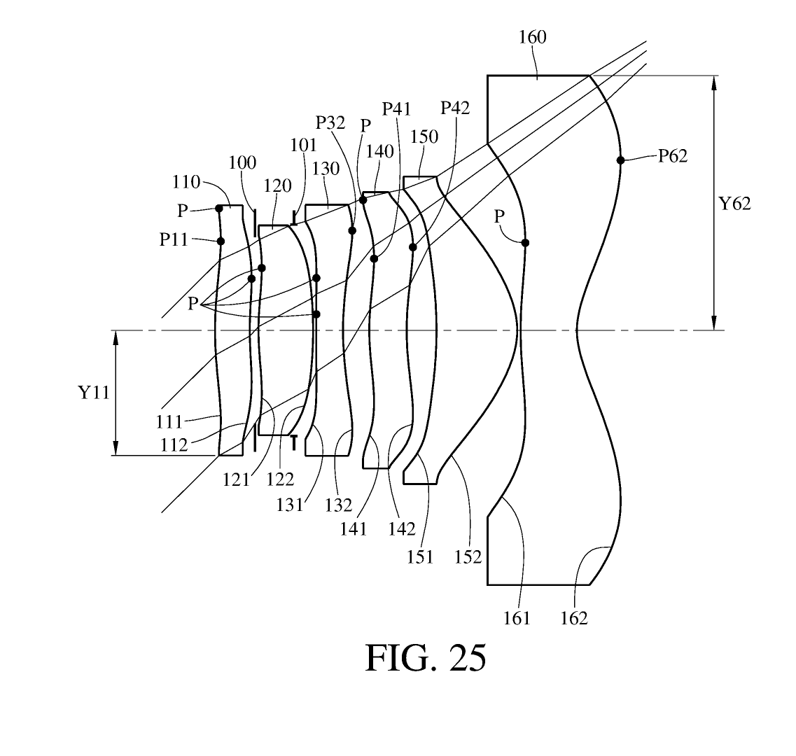

The first lens element can have negative refractive power; therefore, it is favorable for enlarging the field of view. The first lens element can have an object-side surface being convex in a paraxial region thereof; therefore, it is favorable for reducing a total track length of the optical imaging lens assembly. The object-side surface of the first lens element can have at least one concave critical point in an off-axial region thereof; therefore, it is favorable for correcting off-axial aberrations and enlarging the field of view. Please refer to FIG. 25, which shows a schematic view of critical points on each lens element according to the 1st embodiment of the present disclosure, wherein the object-side surface of the first lens element has a concave critical point P11 in an off-axial region thereof.

The second lens element has positive refractive power; therefore, it is favorable for providing sufficient positive refractive power so as to reduce the total track length of the optical imaging lens assembly. The second lens element can have an object-side surface being convex in a paraxial region thereof; therefore, it is favorable for the second lens element having sufficient positive refractive power.

The third lens element has negative refractive power; therefore, it is favorable for correcting spherical aberration and chromatic aberration generated by the first lens element and the second lens element. The third lens element can have an image-side surface being concave in a paraxial region thereof; therefore, it is favorable for correcting astigmatism. The image-side surface of the third lens element can have at least one convex critical point in an off-axial region thereof; therefore, it is favorable for correcting astigmatism and field curvature in the off-axial region. Please refer to FIG. 25, wherein the image-side surface of the third lens element has a convex critical point P32 in an off-axial region thereof.

The fourth lens element can have an object-side surface being convex in a paraxial region thereof; therefore, it is favorable for correcting astigmatism. The fourth lens element can have an image-side surface being concave in a paraxial region thereof; therefore, it is favorable for correcting spherical aberration. The object-side surface of the fourth lens element can have at least one concave critical point in an off-axial region; therefore, it is favorable for correcting off-axial aberrations and reducing surface reflection of light at the off-axial region so as to increase relative illuminance on the periphery of the image surface. The image-side surface of the fourth lens element can have at least one convex critical point; therefore, it is favorable for correcting field curvature in the off-axial region. Please refer to FIG. 25, wherein the object-side surface of the fourth lens element has a concave critical point P41 in an off-axial region thereof, and the image-side surface of the fourth lens element has a convex critical point P42 in an off-axial region thereof.

The fifth lens element has positive refractive power; therefore, it is favorable for providing sufficient light convergence capability and reducing the total track length of the optical imaging lens assembly. The fifth lens element can have an object-side surface being concave in a paraxial region thereof; therefore, it is favorable for reducing surface reflection so as to increase illuminance on the image surface. The fifth lens element can have an image-side surface being convex in a paraxial region thereof; therefore, a shape of the fifth lens element is favorable for cooperating with the six lens element so as to correct off-axial aberrations.

The sixth lens element has negative refractive power; therefore, adjusting the Petzval sum is favorable for correcting astigmatism and field curvature. Preferably, the sixth lens element can have an image-side surface being concave in a paraxial region thereof. The image-side surface of the sixth lens element can have at least one convex critical point in an off-axial region thereof; therefore, it is favorable for correcting off-axial aberrations and reducing surface reflection of light at the off-axial region so as to increase relative illuminance on the periphery of the image surface. Please refer to FIG. 25, wherein the image-side surface of the six lens element has a convex critical point P62 in an off-axial region thereof.

According to the present disclose, among object-side surfaces and image-side surfaces of the six lens elements (the first through the sixth lens elements) of the optical imaging lens assembly, at least one surface has at least one critical point in an off-axial region thereof; therefore, it is favorable for correcting off-axial aberrations, and keeping the optical imaging lens assembly compact. Preferably, at least three of the six lens elements of the optical imaging lens assembly can each have at least one critical point in an off-axial region thereof, wherein the at least one critical point can include a convex critical point or a concave critical point. Please refer to FIG. 25, which shows a schematic view of critical points P, P11, P32, P41, P42 and P62 according to the 1st embodiment of the present disclosure.

When an Abbe number of the sixth lens element is V6, the following condition is satisfied: V6<41. Therefore, it is favorable for correcting chromatic aberration so as to reduce colour cast, and also favorable for correcting off-axial aberrations.

When an axial distance between the first lens element and the second lens element is T12, an axial distance between the second lens element and the third lens element is T23, an axial distance between the third lens element and the fourth lens element is T34, an axial distance between the fourth lens element and the fifth lens element is T45, and an axial distance between the fifth lens element and the sixth lens element is T56, the following condition can be satisfied: 1.5<(T34+T45)/(T12+T23+T56)<50. Therefore, adjusting the axial distances between each two adjacent lens elements in a proper ratio is favorable for reducing spherical aberration and coma so as to enhance image sharpness, and also favorable for enlarging the field of view and increasing image surface area. Preferably, the following condition can be satisfied: 2.3<(T34+T45)/(T12+T23+T56)<30. More preferably, the following condition can be satisfied: 2.6<(T34+T45)/(T12+T23+T56)<20. Much more preferably, the following condition can also be satisfied: 2.7<(T34+T45)/(T12+T23+T56)<10.

When an entrance pupil diameter of the optical imaging lens assembly is EPD, and an axial distance between the object-side surface of the first lens element and the image-side surface of the sixth lens element is TD, the following condition can be satisfied: 0.8<TD/EPD<2.5. Therefore, it is favorable for obtaining a balance between increasing illuminance on the image surface and reducing the size of the optical imaging lens assembly. Preferably, the following condition can also be satisfied: 1.0<TD/EPD<2.1.

When an Abbe number of the fourth lens element is V4, and the Abbe number of the sixth lens element is V6, the following condition can be satisfied: 1.2<(V4+V6)/(V4−V6)<22. Therefore, it is favorable for obtaining a balance between correcting chromatic aberration and correcting astigmatism. Preferably, the following condition can also be satisfied: 1.5<(V4+V6)/(V4−V6)<7.5.

When an Abbe number of the fifth lens element is V5, and the Abbe number of the sixth lens element is V6, the following condition can be satisfied: 1.2<V5/V6<5.0. Therefore, it is favorable for correcting chromatic aberration and off-axial aberrations.

When an axial distance between the object-side surface of the first lens element and an image surface is TL, and a maximum image height of the optical imaging lens assembly (half of a diagonal length of an effective photosensitive area of an image sensor) is ImgH, the following condition can be satisfied: 0.80<TL/ImgH<1.75. Therefore, it is favorable for obtaining a balance between reducing the size of the optical imaging lens assembly and increasing image surface area. Preferably, the following condition can also be satisfied: 1.00<TL/ImgH≤1.50.

When a maximum field of view of the optical imaging lens assembly is FOV, the following condition can be satisfied: 85[deg.]<FOV<150[deg.]. Therefore, it is favorable for the optical imaging lens assembly to meet the requirement of wide field of view.

When a composite focal length of the first lens element, the second lens element and the third lens element is f123, and a composite focal length of the fourth lens element, the fifth lens element and the sixth lens element is f456, the following condition can be satisfied: 1.10<f123/f456. Therefore, the positive refractive power concentrated on the image side of the optical imaging lens assembly is favorable for moving a principal point toward the image side so as to enlarge field of view. Preferably, the following condition can also be satisfied: 1.48≤f123/f456.

When an f-number of the optical imaging lens assembly is Fno, the following condition can be satisfied: 1.00<Fno<1.90. Therefore, it is favorable for the optical imaging lens assembly having sufficient and proper illuminance on the image surface.

When a central thickness of the first lens element is CT1, a central thickness of the second lens element is CT2, and the axial distance between the first lens element and the second lens element is T12, the following condition can be satisfied: (CT1+T12)/CT2<1.0. Therefore, the lens elements are tightly arranged on the object side of the optical imaging lens assembly so as to be favorable for reducing the diameters of the lens elements on the object side, thereby reducing assembling difficulty.

When a central thickness of the fifth lens element is CT5, and a central thickness of the sixth lens element is CT6, the following condition can be satisfied: 1.1<CT5/CT6<2.0. Therefore, it is favorable for adjusting the shapes of the fifth lens element and the sixth lens element so as to correct off-axial aberrations.

When a curvature radius of the object-side surface of the first lens element is R1, and a focal length of the optical imaging lens assembly is f, the following condition can be satisfied: 0.60<|R1|/f. Therefore, it is favorable for reducing the curvatures of the surfaces of the first lens element so as to reduce sensitivity.

When the focal length of the optical imaging lens assembly is f, and a focal length of the first lens element is f1, the following condition can be satisfied: −0.60<f/f1<0.50. Therefore, it is favorable for minimizing spherical aberration and coma, and also favorable for enlarging field of view. Preferably, the following condition can also be satisfied: −0.50<f/f1<0.35.

When a curvature radius of the object-side surface of the second lens element is R3, and a curvature radius of an image-side surface of the second lens element is R4, the following condition can be satisfied: |R3/R4|<4.0. Therefore, adjusting a shape of the second lens element is favorable for correcting spherical aberration and coma.

When the focal length of the optical imaging lens assembly is f, and the maximum image height of the optical imaging lens assembly is ImgH, the following condition can be satisfied: 0.55<f/ImgH<1.1. Therefore, it is favorable for obtaining a balance between enlarging field of view and increasing image surface area.

When a maximum effective radius of the image-side surface of the sixth lens element is Y62, and a curvature radius of the image-side surface of the sixth lens element is R12, the following condition can be satisfied: 1.5<Y62/R12<6.0. Therefore, adjusting a back focal length and lens diameters of the optical imaging lens assembly is favorable for the optical imaging lens assembly to be in compact size. Please refer to FIG. 25, which shows a schematic view of Y62 according to the 1st embodiment of the present disclosure.

When a maximum effective radius of the object-side surface of the first lens element is Y11, and the maximum effective radius of the image-side surface of the sixth lens element is Y62, the following condition can be satisfied: 1.6<Y62/Y11<2.4. Therefore, it is favorable for the optical imaging lens assembly to be in compact size. Please refer to FIG. 25, which shows a schematic view of Y11 and Y62 according to the 1st embodiment of the present disclosure.

According to the present disclosure, the lens elements thereof can be made of glass or plastic material. When the lens elements are made of glass material, the distribution of the refractive power of the lens system may be more flexible to design. When the lens elements are made of plastic material, the manufacturing cost can be effectively reduced. Furthermore, surfaces of each lens element can be arranged to be aspheric, since the aspheric surface of the lens element is easy to form a shape other than spherical surface so as to have more controllable variables for eliminating the aberration thereof, and to further decrease the required number of the lens elements. Therefore, the total track length of the lens system can also be reduced.

According to the present disclosure, each of an object-side surface and an image-side surface has a paraxial region and an off-axis region. The paraxial region refers to the region of the surface where light rays travel close to the optical axis, and the off-axis region refers to the region of the surface away from the paraxial region. Particularly, when the lens element has a convex surface, it indicates that the surface is convex in the paraxial region thereof; when the lens element has a concave surface, it indicates that the surface is concave in the paraxial region thereof. Moreover, when a region of refractive power or focus of a lens element is not defined, it indicates that the region of refractive power or focus of the lens element is in the paraxial region thereof.

According to the present disclosure, a critical point is a non-axial point of the lens surface where its tangent is perpendicular to the optical axis.

According to the present disclosure, an image surface of the optical imaging lens assembly, based on the corresponding image sensor, can be flat or curved, especially a curved surface being concave facing towards the object side of the optical imaging lens assembly. Furthermore, an image correction unit, such as a field flattener, can be optionally disposed between the lens element closest to the image-side of the optical imaging lens system and the image surface for correction of aberrations such as field curvature. The optical properties of the image correction unit, such as curvature, thickness, index of refraction, position and surface shape (convex or concave surface with spherical, aspheric, diffraction or Fresnel morphology), can be adjusted according to the demand of an image capturing unit. In general, a preferable image correction unit is, for example, a thin element having a concave object-side surface and a planar image-side surface, and the thin element is disposed near the image surface.

According to the present disclosure, the optical imaging lens assembly can include at least one stop, such as an aperture stop, a glare stop or a field stop. Said glare stop or said field stop is set for eliminating the stray light and thereby improving the image quality thereof.

According to the present disclosure, an aperture stop can be configured as a front stop or a middle stop. A front stop disposed between an imaged object and the first lens element can provide a longer distance between an exit pupil of the lens system and the image surface to produce a telecentric effect, and thereby improves the image-sensing efficiency of an image sensor (for example, CCD or CMOS). A middle stop disposed between the first lens element and the image surface is favorable for enlarging the view angle of the optical imaging lens assembly and thereby provides a wider field of view for the same.

According to the above description of the present disclosure, the following specific embodiments are provided for further explanation.

### 1st Embodiment

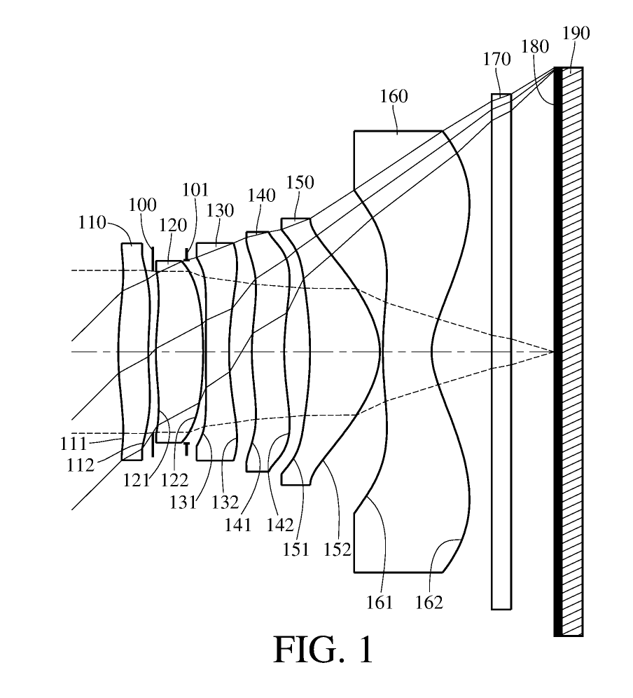

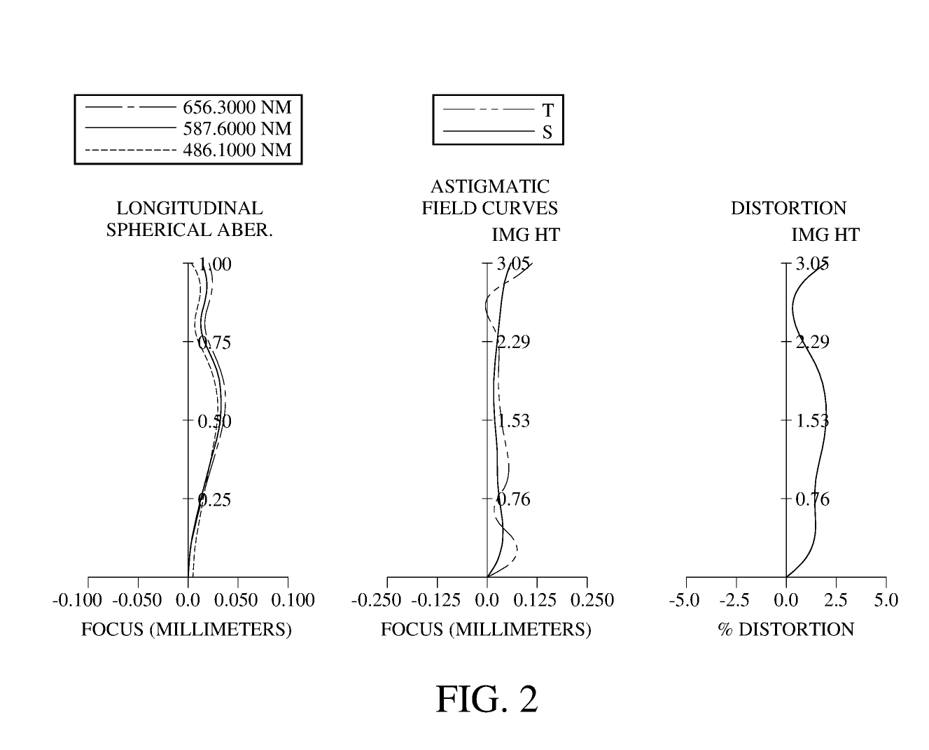

FIG. 1 is a schematic view of an image capturing unit according to the 1st embodiment of the present disclosure. FIG. 2 shows, in order from left to right, spherical aberration curves, astigmatic field curves and a distortion curve of the image capturing unit according to the 1st embodiment. In FIG. 1, the image capturing unit includes the optical imaging lens assembly (its reference numeral is omitted) of the present disclosure and an image sensor 190. The optical imaging lens assembly includes, in order from an object side to an image side, a first lens element 110, an aperture stop 100, a second lens element 120, a stop 101, a third lens element 130, a fourth lens element 140, a fifth lens element 150, a sixth lens element 160, an IR-cut filter 170 and an image surface 180. The optical imaging lens assembly includes six lens elements (110, 120, 130, 140, 150 and 160) with no additional lens element disposed between the first lens element 110 and the sixth lens element 160.

The first lens element 110 with negative refractive power has an object-side surface 111 being convex in a paraxial region thereof and an image-side surface 112 being concave in a paraxial region thereof. The first lens element 110 is made of plastic material and has the object-side surface 111 and the image-side surface 112 being both aspheric. The object-side surface 111 of the first lens element 110 has at least one concave critical point in an off-axial region thereof. The image-side surface 112 of the first lens element 110 has at least one critical point in an off-axial region thereof.

The second lens element 120 with positive refractive power has an object-side surface 121 being convex in a paraxial region thereof and an image-side surface 122 being convex in a paraxial region thereof. The second lens element 120 is made of plastic material and has the object-side surface 121 and the image-side surface 122 being both aspheric. The object-side surface 121 of the second lens element 120 has at least one critical point in an off-axial region thereof.

The third lens element 130 with negative refractive power has an object-side surface 131 being concave in a paraxial region thereof and an image-side surface 132 being concave in a paraxial region thereof. The third lens element 130 is made of plastic material and has the object-side surface 131 and the image-side surface 132 being both aspheric. The object-side surface 131 of the third lens element 130 has at least one critical point in an off-axial region thereof. The image-side surface 132 of the third lens element 130 has at least one convex critical point in an off-axial region thereof.

The fourth lens element 140 with positive refractive power has an object-side surface 141 being convex in a paraxial region thereof and an image-side surface 142 being concave in a paraxial region thereof. The fourth lens element 140 is made of plastic material and has the object-side surface 141 and the image-side surface 142 being both aspheric. The object-side surface 141 of the fourth lens element 140 has at least one concave critical point in an off-axial region thereof. The image-side surface 142 of the fourth lens element 140 has at least one convex critical point in an off-axial region thereof.

The fifth lens element 150 with positive refractive power has an object-side surface 151 being concave in a paraxial region thereof and an image-side surface 152 being convex in a paraxial region thereof. The fifth lens element 150 is made of plastic material and has the object-side surface 151 and the image-side surface 152 being both aspheric.

The sixth lens element 160 with negative refractive power has an object-side surface 161 being convex in a paraxial region thereof and an image-side surface 162 being concave in a paraxial region thereof. The sixth lens element 160 is made of plastic material and has the object-side surface 161 and the image-side surface 162 being both aspheric. The object-side surface 161 of the sixth lens element 160 has at least one critical point in an off-axial region thereof. The image-side surface 162 of the sixth lens element 160 has at least one convex critical point in an off-axial region thereof.

The IR-cut filter 170 is made of glass and located between the sixth lens element 160 and the image surface 180, and will not affect the focal length of the optical imaging lens assembly. The image sensor 190 is disposed on or near the image surface 180 of the optical imaging lens assembly.

The equation of the aspheric surface profiles of the aforementioned lens elements of the 1st embodiment is expressed as follows:

$$X ( Y ) = ( {Y}^{2} / R ) / ( 1 + sqrt ( 1 - ( 1 + k ) \times {( Y / R )}^{2} ) ) + {\sum }_{i} ( Ai ) \times ( {Y}^{i} ) ,$$

where,

X is the relative distance between a point on the aspheric surface spaced at a distance Y from an optical axis and the tangential plane at the aspheric surface vertex on the optical axis;

Y is the vertical distance from the point on the aspheric surface to the optical axis;

R is the curvature radius;

k is the conic coefficient; and

Ai is the i-th aspheric coefficient, and in the embodiments, i may be, but is not limited to, 4, 6, 8, 10, 12, 14 and 16.

In the optical imaging lens assembly of the image capturing unit according to the 1st embodiment, when a focal length of the optical imaging lens assembly is f, an f-number of the optical imaging lens assembly is Fno, and half of a maximum field of view of the optical imaging lens assembly is HFOV, these parameters have the following values: f=2.99 millimeters (mm), Fno=1.70, HFOV=44.8 degrees (deg.).

When an Abbe number of the fourth lens element 140 is V4, and an Abbe number of the sixth lens element 160 is V6, the following condition is satisfied: (V4+V6)/(V4−V6)=5.04.

When an Abbe number of the fifth lens element 150 is V5, and the Abbe number of the sixth lens element 160 is V6, the following condition is satisfied: V5/V6=1.50.

When the Abbe number of the sixth lens element 160 is V6, the following condition is satisfied: V6=37.4.

When a central thickness of the first lens element 110 is CT1, a central thickness of the second lens element 120 is CT2, and an axial distance between the first lens element 110 and the second lens element 120 is T12, the following condition is satisfied: (CT1+T12)/CT2=0.80. In this embodiment, the axial distance between two adjacent lens elements is the air gap in a paraxial region between the two adjacent lens elements.

When a central thickness of the fifth lens element 150 is CT5, and a central thickness of the sixth lens element 160 is CT6, the following condition is satisfied: CT5/CT6=1.43.

When the axial distance between the first lens element 110 and the second lens element 120 is T12, an axial distance between the second lens element 120 and the third lens element 130 is T23, an axial distance between the third lens element 130 and the fourth lens element 140 is T34, an axial distance between the fourth lens element 140 and the fifth lens element 150 is T45, and an axial distance between the fifth lens element 150 and the sixth lens element 160 is T56, the following condition is satisfied: (T34+T45)/(T12+T23+T56)=3.65.

When an entrance pupil diameter of the optical imaging lens assembly is EPD, and an axial distance between the object-side surface 111 of the first lens element 110 and the image-side surface 162 of the sixth lens element 160 is TD, the following condition is satisfied: TD/EPD=1.92.

When a maximum image height of the optical imaging lens assembly is ImgH, and an axial distance between the object-side surface 111 of the first lens element 110 and the image surface 180 is TL, the following condition is satisfied: TL/ImgH=1.55.

When a curvature radius of the object-side surface 111 of the first lens element 110 is R1, and the focal length of the optical imaging lens assembly is f, the following condition is satisfied: |R1|/f=1.13.

When a curvature radius of the object-side surface 121 of the second lens element 120 is R3, and a curvature radius of the image-side surface 122 of the second lens element 120 is R4, the following condition is satisfied: |R3/R4|=0.69.

When the focal length of the optical imaging lens assembly is f, and a focal length of the first lens element 110 is f1, the following condition is satisfied: f/f1=−0.01.

When the focal length of the optical imaging lens assembly is f, and the maximum image height of the optical imaging lens assembly is ImgH, the following condition is satisfied: f/ImgH=0.98.

When a composite focal length of the first lens element 110, the second lens element 120 and the third lens element 130 is f123, and a composite focal length of the fourth lens element 140, the fifth lens element 150 and the sixth lens element 160 is f456, the following condition is satisfied: f123/f456=1.82.

When the maximum field of view of the optical imaging lens assembly is FOV, the following condition is satisfied: FOV=89.7 degrees.

When a maximum effective radius of the image-side surface 162 of the sixth lens element 160 is Y62, and a curvature radius of the image-side surface 162 of the sixth lens element 160 is R12, the following condition is satisfied: Y62/R12=3.32.

When a maximum effective radius of the object-side surface 111 of the first lens element 110 is Y11, and the maximum effective radius of the image-side surface 162 of the sixth lens element 160 is Y62, the following condition is satisfied: Y62/Y11=2.04.

The detailed optical data of the 1st embodiment are shown in Table 1 and the aspheric surface data are shown in Table 2 below.

TABLE 1
1st Embodiment
f = 2.99 mm, Fno = 1.70, HFOV = 44.8 deg.

| Surface | | Curvature | | | | | Abbe | Focal |
|---|---|---|---|---|---|---|---|---|
| # | | Radius | | Thickness | Material | Index | # | Length |
| 0 | Object | Plano | | Infinity | | | | |
| 1 | Lens 1 | 3.396 | (ASP) | 0.325 | Plastic | 1.545 | 56.0 | −203.88 |
| 2 | | 3.184 | (ASP) | 0.049 | | | | |
| 3 | Ape. Stop | Plano | | 0.033 | | | | |
| 4 | Lens 2 | 2.583 | (ASP) | 0.511 | Plastic | 1.544 | 56.0 | 2.89 |
| 5 | | −3.743 | (ASP) | −0.179 | | | | |
| 6 | Stop | Plano | | 0.209 | | | | |
| 7 | Lens 3 | −140.130 | (ASP) | 0.250 | Plastic | 1.642 | 22.5 | −4.28 |
| 8 | | 2.800 | (ASP) | 0.246 | | | | |
| 9 | Lens 4 | 2.316 | (ASP) | 0.350 | Plastic | 1.544 | 56.0 | 32.99 |
| 10 | | 2.517 | (ASP) | 0.279 | | | | |
| 11 | Lens 5 | −4.146 | (ASP) | 0.756 | Plastic | 1.544 | 56.0 | 1.49 |
| 12 | | −0.721 | (ASP) | 0.032 | | | | |
| 13 | Lens 6 | 3.834 | (ASP) | 0.527 | Plastic | 1.566 | 37.4 | −1.66 |
| 14 | | 0.718 | (ASP) | 0.650 | | | | |

| | | | | | | | |
|---|---|---|---|---|---|---|---|
| 15 | IR-cut filter | Plano | 0.210 | Glass | 1.517 | 64.2 | — |
| 16 | | Plano | 0.470 | | | | |
| 17 | Image | Plano | — | | | | |

Note:
Reference wavelength is 587.6 nm (d-line).
An effective radius of the stop 101 (Surface 6) is 0.990 mm.

TABLE 2
Aspheric Coefficients

| Surface # | 1 | 2 | 4 | 5 | 7 | 8 |
|---|---|---|---|---|---|---|
| k= | −6.0042E−02 | 6.3893E+00 | −3.2490E+01 | −2.5663E+00 | −9.0000E+01 | 2.3739E+00 |
| A4= | −1.0535E−01 | −4.2004E−01 | −8.8496E−02 | 1.1194E−01 | 8.9149E−02 | −2.0544E−01 |
| A6= | 3.5938E−02 | 7.6168E−02 | −5.9577E−01 | −7.1818E−01 | −3.3756E−01 | 4.5173E−01 |
| A8= | −7.9234E−02 | 3.0769E−01 | 1.3733E+00 | 1.1620E+00 | 5.2325E−01 | −7.7382E−01 |
| A10= | 4.6939E−02 | −3.4785E−01 | −1.1552E+00 | −9.9720E−01 | −7.0139E−01 | 6.1749E−01 |
| A12= | −1.7850E−03 | 1.1944E−01 | 3.0751E−01 | 3.1983E−01 | 4.0662E−01 | −2.5225E−01 |
| A14= | — | — | — | — | −6.7351E−02 | 4.3018E−02 |
| Surface # | 9 | 10 | 11 | 12 | 13 | 14 |
| k= | −3.6986E+01 | −5.9204E+01 | 4.0060E+00 | −5.0167E+00 | 1.2305E+00 | −4.9707E+00 |
| A4= | 1.6782E−03 | 1.2910E−01 | −4.6842E−02 | −4.6299E−01 | −9.9472E−02 | −5.6270E−02 |
| A6= | −4.4363E−01 | −4.8579E−01 | 3.7928E−01 | 9.5918E−01 | −9.8330E−03 | 1.3704E−02 |
| A8= | 7.3204E−01 | 6.0317E−01 | −8.6236E−01 | −1.4269E+00 | 6.9488E−03 | −2.9365E−03 |
| A10= | −6.8356E−01 | −4.4154E−01 | 1.1416E+00 | 1.3460E+00 | 3.8062E−03 | 3.8562E−04 |
| A12= | 3.3874E−01 | 1.3163E−01 | −8.9653E−01 | −7.4477E−01 | −4.3917E−03 | −5.1132E−05 |
| A14= | −6.3735E−02 | −5.7061E−03 | 3.5939E−01 | 2.2101E−01 | 1.4710E−03 | 7.3453E−06 |
| A16= | — | — | −5.5851E−02 | −2.6917E−02 | −1.6644E−04 | −4.7364E−07 |

In Table 1, the curvature radius, the thickness and the focal length are shown in millimeters (mm). Surface numbers 0-17 represent the surfaces sequentially arranged from the object side to the image side along the optical axis. In Table 2, k represents the conic coefficient of the equation of the aspheric surface profiles. A4-A16 represent the aspheric coefficients ranging from the 4th order to the 16th order. The tables presented below for each embodiment are the corresponding schematic parameter and aberration curves, and the definitions of the tables are the same as Table 1 and Table 2 of the 1st embodiment. Therefore, an explanation in this regard will not be provided again.

### 2nd Embodiment

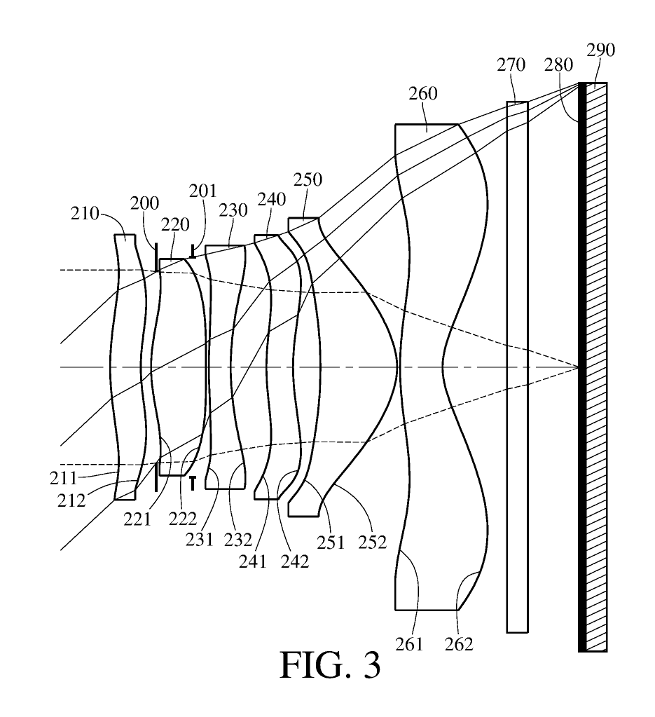

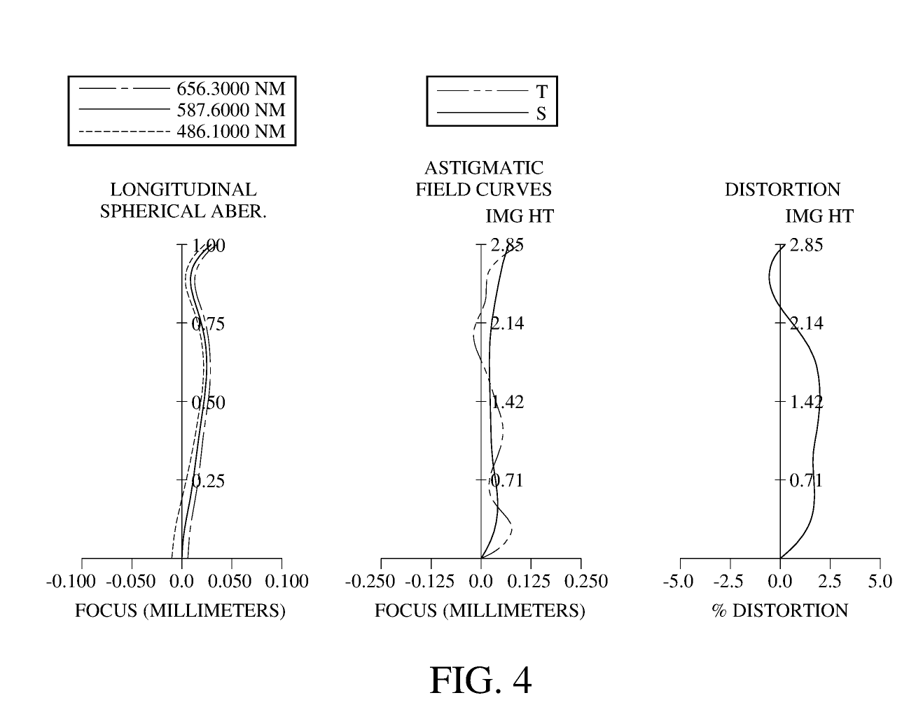

FIG. 3 is a schematic view of an image capturing unit according to the 2nd embodiment of the present disclosure. FIG. 4 shows, in order from left to right, spherical aberration curves, astigmatic field curves and a distortion curve of the image capturing unit according to the 2nd embodiment. In FIG. 3, the image capturing unit includes the optical imaging lens assembly (its reference numeral is omitted) of the present disclosure and an image sensor 290. The optical imaging lens assembly includes, in order from an object side to an image side, a first lens element 210, an aperture stop 200, a second lens element 220, a stop 201, a third lens element 230, a fourth lens element 240, a fifth lens element 250, a sixth lens element 260, an IR-cut filter 270 and an image surface 280. The optical imaging lens assembly includes six lens elements (210, 220, 230, 240, 250 and 260) with no additional lens element disposed between the first lens element 210 and the sixth lens element 260.

The first lens element 210 with negative refractive power has an object-side surface 211 being convex in a paraxial region thereof and an image-side surface 212 being concave in a paraxial region thereof. The first lens element 210 is made of plastic material and has the object-side surface 211 and the image-side surface 212 being both aspheric. The object-side surface 211 of the first lens element 210 has at least one concave critical point in an off-axial region thereof. The image-side surface 212 of the first lens element 210 has at least one critical point in an off-axial region thereof.

The second lens element 220 with positive refractive power has an object-side surface 221 being convex in a paraxial region thereof and an image-side surface 222 being concave in a paraxial region thereof. The second lens element 220 is made of plastic material and has the object-side surface 221 and the image-side surface 222 being both aspheric. Both the object-side surface 221 and the image-side surface 222 of the second lens element 220 have at least one critical point in an off-axial region thereof.

The third lens element 230 with negative refractive power has an object-side surface 231 being convex in a paraxial region thereof and an image-side surface 232 being concave in a paraxial region thereof. The third lens element 230 is made of plastic material and has the object-side surface 231 and the image-side surface 232 being both aspheric. The object-side surface 231 of the third lens element 230 has at least one critical point in an off-axial region thereof. The image-side surface 232 of the third lens element 230 has at least one convex critical point in an off-axial region thereof.

The fourth lens element 240 with negative refractive power has an object-side surface 241 being convex in a paraxial region thereof and an image-side surface 242 being concave in a paraxial region thereof. The fourth lens element 240 is made of plastic material and has the object-side surface 241 and the image-side surface 242 being both aspheric. The object-side surface 241 of the fourth lens element 240 has at least one concave critical point in an off-axial region thereof. The image-side surface 242 of the fourth lens element 240 has at least one convex critical point in an off-axial region thereof.

The fifth lens element 250 with positive refractive power has an object-side surface 251 being concave in a paraxial region thereof and an image-side surface 252 being convex in a paraxial region thereof. The fifth lens element 250 is made of plastic material and has the object-side surface 251 and the image-side surface 252 being both aspheric.

The sixth lens element 260 with negative refractive power has an object-side surface 261 being convex in a paraxial region thereof and an image-side surface 262 being concave in a paraxial region thereof. The sixth lens element 260 is made of plastic material and has the object-side surface 261 and the image-side surface 262 being both aspheric. The object-side surface 261 of the sixth lens element 260 has at least one critical point in an off-axial region thereof. The image-side surface 262 of the sixth lens element 260 has at least one convex critical point in an off-axial region thereof.

The IR-cut filter 270 is made of glass and located between the sixth lens element 260 and the image surface 280, and will not affect the focal length of the optical imaging lens assembly. The image sensor 290 is disposed on or near the image surface 280 of the optical imaging lens assembly.

The detailed optical data of the 2nd embodiment are shown in Table 3 and the aspheric surface data are shown in Table 4 below.

TABLE 3
2nd Embodiment
f = 3.04 mm, Fno = 1.55, HFOV = 43.0 deg.

| | | Curvature | | | | | | Focal |
|---|---|---|---|---|---|---|---|---|
| Surface # | | Radius | | Thickness | Material | Index | Abbe # | Length |
| 0 | Object | Plano | | Infinity | | | | |
| 1 | Lens 1 | 2.578 | (ASP) | 0.309 | Plastic | 1.545 | 56.0 | −11.05 |
| 2 | | 1.729 | (ASP) | 0.155 | | | | |
| 3 | Ape. Stop | Plano | | −0.051 | | | | |
| 4 | Lens 2 | 1.543 | (ASP) | 0.553 | Plastic | 1.544 | 56.0 | 2.90 |
| 5 | | 58.152 | (ASP) | −0.133 | | | | |
| 6 | Stop | Plano | | 0.163 | | | | |
| 7 | Lens 3 | 4.250 | (ASP) | 0.220 | Plastic | 1.660 | 20.4 | −8.68 |
| 8 | | 2.390 | (ASP) | 0.361 | | | | |
| 9 | Lens 4 | 2.238 | (ASP) | 0.269 | Plastic | 1.544 | 56.0 | −101.34 |
| 10 | | 2.059 | (ASP) | 0.276 | | | | |
| 11 | Lens 5 | −4.567 | (ASP) | 0.774 | Plastic | 1.544 | 56.0 | 1.37 |
| 12 | | −0.679 | (ASP) | 0.030 | | | | |
| 13 | Lens 6 | 2.972 | (ASP) | 0.429 | Plastic | 1.566 | 37.4 | −1.60 |
| 14 | | 0.658 | (ASP) | 0.650 | | | | |

| | | | | | | | |
|---|---|---|---|---|---|---|---|
| 15 | IR-cut filter | Plano | 0.210 | Glass | 1.517 | 64.2 | — |
| 16 | | Plano | 0.516 | | | | |
| 17 | Image | Plano | — | | | | |

Note:
Reference wavelength is 587.6 nm (d-line).
An effective radius of the stop 201 (Surface 6) is 1.110 mm.

TABLE 4
Aspheric Coefficients

| Surface # | 1 | 2 | 4 | 5 | 7 | 8 |
|---|---|---|---|---|---|---|
| k= | −1.7844E+00 | −5.8426E+00 | −8.7850E+00 | 9.0000E+01 | −1.6119E+01 | 9.3306E−01 |
| A4= | −1.3031E−01 | −3.4279E−01 | −1.6337E−02 | −2.8759E−01 | −3.7079E−01 | −2.7939E−01 |
| A6= | 8.9025E−02 | 9.6489E−02 | −4.9344E−01 | 3.3574E−01 | 8.4575E−01 | 6.9087E−01 |
| A8= | −1.0319E−01 | 1.1323E−01 | 6.7632E−01 | −3.2437E−01 | −9.4032E−01 | −9.8597E−01 |
| A10= | 4.8264E−02 | −1.0697E−01 | −3.1364E−01 | 1.5492E−01 | 4.0358E−01 | 7.0641E−01 |
| A12= | −6.2888E−03 | 2.8776E−02 | 1.8619E−02 | −3.6869E−02 | −2.5041E−02 | −2.6146E−01 |
| A14= | — | — | — | — | −1.3499E−02 | 3.9407E−02 |
| Surface # | 9 | 10 | 11 | 12 | 13 | 14 |
| k= | −2.0480E+01 | −2.6605E+01 | −8.8660E+01 | −4.8083E+00 | −9.2713E−01 | −4.9984E+00 |
| A4= | −1.3346E−01 | 8.6128E−03 | −2.0316E−01 | −3.7757E−01 | −8.3125E−02 | −3.9654E−02 |
| A6= | 6.4769E−02 | −9.6379E−02 | 4.7433E−01 | 6.4725E−01 | 4.2138E−03 | 4.4618E−03 |
| A8= | −3.1495E−01 | −3.9939E−02 | −7.4577E−01 | −8.4320E−01 | 3.9564E−03 | 1.2875E−04 |
| A10= | 4.4808E−01 | 1.6438E−01 | 8.2744E−01 | 6.9439E−01 | −1.2457E−03 | −2.9687E−04 |
| A12= | −2.6086E−01 | −1.4811E−01 | −5.8153E−01 | −3.2724E−01 | 2.5435E−04 | 5.2883E−05 |
| A14= | 5.5855E−02 | 4.1430E−02 | 2.1106E−01 | 8.2339E−02 | −3.3512E−05 | −2.4795E−06 |
| A16= | — | — | −2.9575E−02 | −8.6072E−03 | 1.8094E−06 | −4.7269E−08 |

In the 2nd embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 2nd embodiment, so an explanation in this regard will not be provided again.

Moreover, these parameters can be calculated from Table 3 and Table 4 as the following values and satisfy the following conditions:

2nd Embodiment

| | | | |
|---|---|---|---|
| f [mm] | 3.04 | TL/ImgH | 1.66 |
| Fno | 1.55 | \|R1\|/f | 0.85 |
| HFOV [deg.] | 43.0 | \|R3/R4\| | 0.03 |
| (V4 + V6)/(V4 − V6) | 5.04 | f/f1 | −0.28 |
| V5/V6 | 1.50 | f/ImgH | 1.07 |
| V6 | 37.4 | f123/f456 | 1.55 |
| (CT1 + T12)/CT2 | 0.75 | FOV [deg.] | 86.0 |
| CT5/CT6 | 1.80 | Y62/R12 | 3.72 |
| (T34 + T45)/(T12 + T23 + T56) | 3.88 | Y62/Y11 | 1.83 |
| TD/EPD | 1.71 | — | — |

### 3rd Embodiment

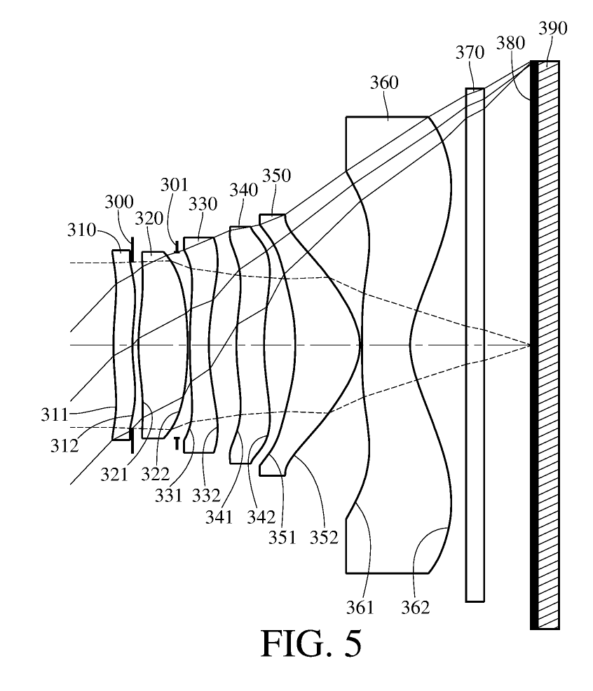

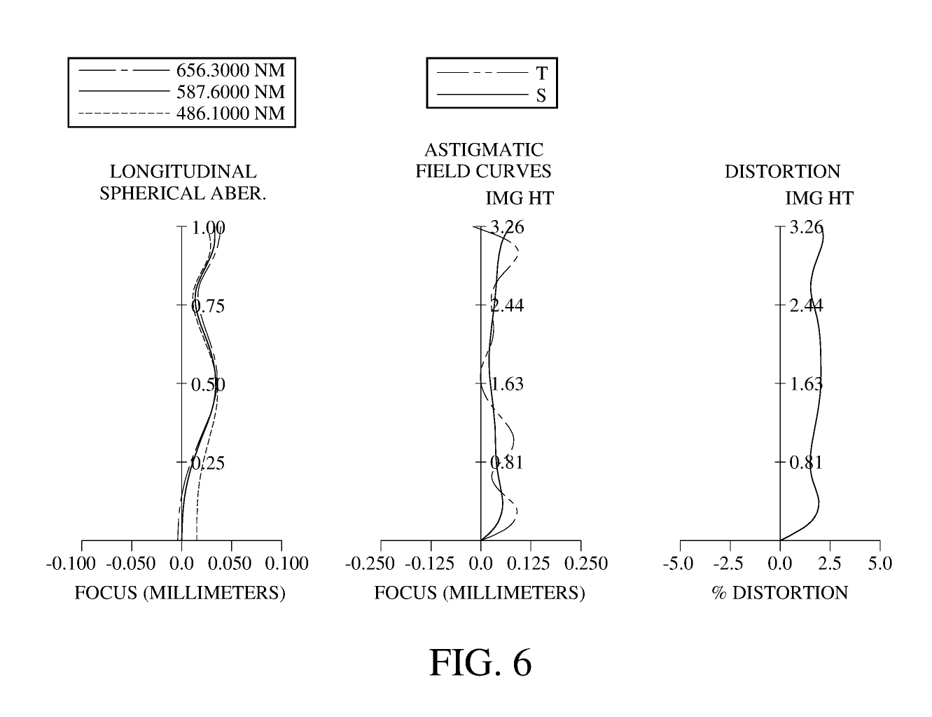

FIG. 5 is a schematic view of an image capturing unit according to the 3rd embodiment of the present disclosure. FIG. 6 shows, in order from left to right, spherical aberration curves, astigmatic field curves and a distortion curve of the image capturing unit according to the 3rd embodiment. In FIG. 5, the image capturing unit includes the optical imaging lens assembly (its reference numeral is omitted) of the present disclosure and an image sensor 390. The optical imaging lens assembly includes, in order from an object side to an image side, a first lens element 310, an aperture stop 300, a second lens element 320, a stop 301, a third lens element 330, a fourth lens element 340, a fifth lens element 350, a sixth lens element 360, an IR-cut filter 370 and an image surface 380. The optical imaging lens assembly includes six lens elements (310, 320, 330, 340, 350 and 360) with no additional lens element disposed between the first lens element 310 and the sixth lens element 360.

The first lens element 310 with negative refractive power has an object-side surface 311 being convex in a paraxial region thereof and an image-side surface 312 being concave in a paraxial region thereof. The first lens element 310 is made of plastic material and has the object-side surface 311 and the image-side surface 312 being both aspheric. The object-side surface 311 of the first lens element 310 has at least one concave critical point in an off-axial region thereof. The image-side surface 312 of the first lens element 310 has at least one critical point in an off-axial region thereof.

The second lens element 320 with positive refractive power has an object-side surface 321 being convex in a paraxial region thereof and an image-side surface 322 being convex in a paraxial region thereof. The second lens element 320 is made of plastic material and has the object-side surface 321 and the image-side surface 322 being both aspheric. The object-side surface 321 of the second lens element 320 has at least one critical point in an off-axial region thereof.

The third lens element 330 with negative refractive power has an object-side surface 331 being convex in a paraxial region thereof and an image-side surface 332 being concave in a paraxial region thereof. The third lens element 330 is made of plastic material and has the object-side surface 331 and the image-side surface 332 being both aspheric. The object-side surface 331 of the third lens element 330 has at least one critical point in an off-axial region thereof. The image-side surface 332 of the third lens element 330 has at least one convex critical point in an off-axial region thereof.

The fourth lens element 340 with positive refractive power has an object-side surface 341 being convex in a paraxial region thereof and an image-side surface 342 being concave in a paraxial region thereof. The fourth lens element 340 is made of plastic material and has the object-side surface 341 and the image-side surface 342 being both aspheric. The object-side surface 341 of the fourth lens element 340 has at least one concave critical point in an off-axial region thereof. The image-side surface 342 of the fourth lens element 340 has at least one convex critical point in an off-axial region thereof.

The fifth lens element 350 with positive refractive power has an object-side surface 351 being concave in a paraxial region thereof and an image-side surface 352 being convex in a paraxial region thereof. The fifth lens element 350 is made of plastic material and has the object-side surface 351 and the image-side surface 352 being both aspheric. The image-side surface 352 of the fifth lens element 350 has at least one critical point in an off-axial region thereof.

The sixth lens element 360 with negative refractive power has an object-side surface 361 being concave in a paraxial region thereof and an image-side surface 362 being concave in a paraxial region thereof. The sixth lens element 360 is made of plastic material and has the object-side surface 361 and the image-side surface 362 being both aspheric. The object-side surface 361 of the sixth lens element 360 has at least one critical point in an off-axial region thereof. The image-side surface 362 of the sixth lens element 360 has at least one convex critical point in an off-axial region thereof.

The IR-cut filter 370 is made of glass and located between the sixth lens element 360 and the image surface 380, and will not affect the focal length of the optical imaging lens assembly. The image sensor 390 is disposed on or near the image surface 380 of the optical imaging lens assembly.

The detailed optical data of the 3rd embodiment are shown in Table 5 and the aspheric surface data are shown in Table 6 below.

TABLE 5
3rd Embodiment
f = 3.02 mm, Fno = 1.58, HFOV = 46.5 deg.

| Surface | | Curvature | | | | | | Focal |
|---|---|---|---|---|---|---|---|---|
| # | | Radius | | Thickness | Material | Index | Abbe # | Length |
| 0 | Object | Plano | | Infinity | | | | |
| 1 | Lens 1 | 3.408 | (ASP) | 0.220 | Plastic | 1.545 | 56.0 | −12.15 |
| 2 | | 2.198 | (ASP) | 0.001 | | | | |
| 3 | Ape. Stop | Plano | | 0.069 | | | | |
| 4 | Lens 2 | 2.347 | (ASP) | 0.571 | Plastic | 1.544 | 56.0 | 2.68 |
| 5 | | −3.527 | (ASP) | −0.125 | | | | |
| 6 | Stop | Plano | | 0.150 | | | | |
| 7 | Lens 3 | 5.602 | (ASP) | 0.220 | Plastic | 1.669 | 19.5 | −5.80 |
| 8 | | 2.256 | (ASP) | 0.320 | | | | |
| 9 | Lens 4 | 2.367 | (ASP) | 0.321 | Plastic | 1.544 | 56.0 | 50.04 |
| 10 | | 2.469 | (ASP) | 0.362 | | | | |
| 11 | Lens 5 | −2.885 | (ASP) | 0.750 | Plastic | 1.544 | 56.0 | 1.24 |
| 12 | | −0.596 | (ASP) | 0.025 | | | | |
| 13 | Lens 6 | −212.766 | (ASP) | 0.557 | Plastic | 1.582 | 30.2 | −1.35 |
| 14 | | 0.788 | (ASP) | 0.650 | | | | |

| | | | | | | | |
|---|---|---|---|---|---|---|---|
| 15 | IR-cut filter | Plano | 0.210 | Glass | 1.517 | 64.2 | — |
| 16 | | Plano | 0.542 | | | | |
| 17 | Image | Plano | — | | | | |

Note:
Reference wavelength is 587.6 nm (d-line).
An effective radius of the stop 301 (Surface 6) is 1.080 mm.

TABLE 6
Aspheric Coefficients

| Surface # | 1 | 2 | 4 | 5 | 7 | 8 |
|---|---|---|---|---|---|---|
| k= | −6.0781E−01 | −5.9783E+00 | −1.3707E+01 | −2.1192E+01 | −2.4528E+00 | 9.3739E−01 |
| A4= | −2.0332E−01 | −3.3306E−01 | −4.0946E−02 | 4.6033E−02 | −4.9611E−02 | −2.7097E−01 |
| A6= | 1.4313E−01 | −2.9897E−01 | −7.1767E−01 | −3.8573E−01 | −7.8074E−02 | 4.6038E−01 |
| A8= | −2.6244E−01 | 1.0117E+00 | 1.5441E+00 | 4.7980E−01 | 2.3655E−01 | −6.4693E−01 |
| A10= | 2.3026E−01 | −9.2677E−01 | −1.2843E+00 | −3.3608E−01 | −5.2577E−01 | 4.3549E−01 |
| A12= | −5.8450E−02 | 3.3077E−01 | 3.8987E−01 | 9.2732E−02 | 4.2973E−01 | −1.4028E−01 |
| A14= | — | — | — | — | −1.1925E−01 | 1.6700E−02 |
| Surface # | 9 | 10 | 11 | 12 | 13 | 14 |
| k= | −5.3807E+01 | −8.8242E+01 | −1.6298E+01 | −4.1292E+00 | −9.0000E+01 | −7.3123E+00 |
| A4= | 1.0462E−01 | 1.6877E−01 | −3.9317E−01 | −4.7203E−01 | 2.6513E−01 | 4.5850E−02 |
| A6= | −5.4665E−01 | −4.2156E−01 | 1.1638E+00 | 1.0011E+00 | −3.2896E−01 | −5.8860E−02 |
| A8= | 6.6629E−01 | 3.7650E−01 | −1.8737E+00 | −1.3621E+00 | 1.9681E−01 | 2.6659E−02 |
| A10= | −4.9240E−01 | −1.7556E−01 | 1.8526E+00 | 1.1127E+00 | −7.1934E−02 | −6.8522E−03 |
| A12= | 2.0849E−01 | 1.4830E−02 | −1.1084E+00 | −5.2873E−01 | 1.5823E−02 | 1.0138E−03 |
| A14= | −3.5102E−02 | 8.3790E−03 | 3.5619E−01 | 1.3619E−01 | −1.8997E−03 | −7.9897E−05 |
| A16= | — | — | −4.6496E−02 | −1.4636E−02 | 9.5175E−05 | 2.5854E−06 |

In the 3rd embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 3rd embodiment, so an explanation in this regard will not be provided again.

Moreover, these parameters can be calculated from Table 5 and Table 6 as the following values and satisfy the following conditions:

3rd Embodiment

| | | | |
|---|---|---|---|
| f [mm] | 3.02 | TL/ImgH | 1.49 |
| Fno | 1.58 | \|R1\|/f | 1.13 |
| HFOV [deg.] | 46.5 | \|R3/R4\| | 0.67 |
| (V4 + V6)/(V4 − V6) | 3.35 | f/f1 | −0.25 |
| V5/V6 | 1.85 | f/ImgH | 0.93 |
| V6 | 30.2 | f123/f456 | 1.65 |
| (CT1 + T12)/CT2 | 0.51 | FOV [deg.] | 93.0 |
| CT5/CT6 | 1.35 | Y62/R12 | 3.36 |
| (T34 + T45)/(T12 + T23 + T56) | 5.68 | Y62/Y11 | 2.40 |
| TD/EPD | 1.80 | — | — |

### 4th Embodiment

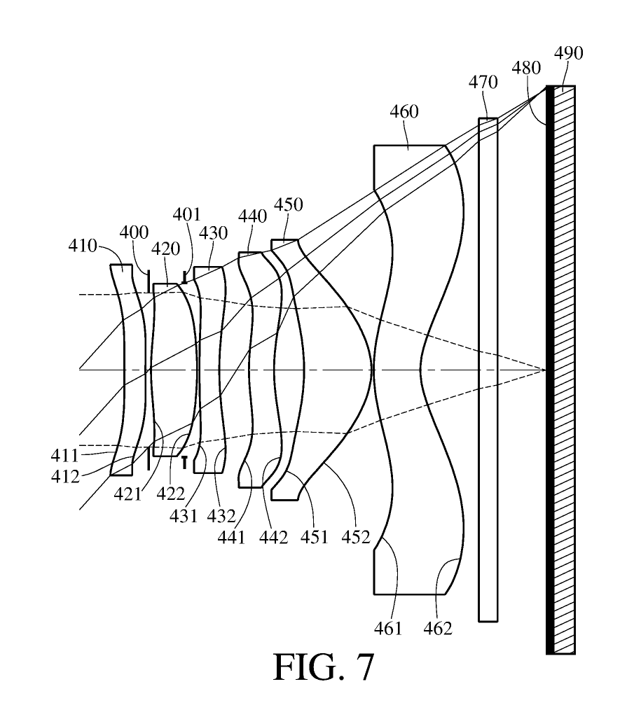

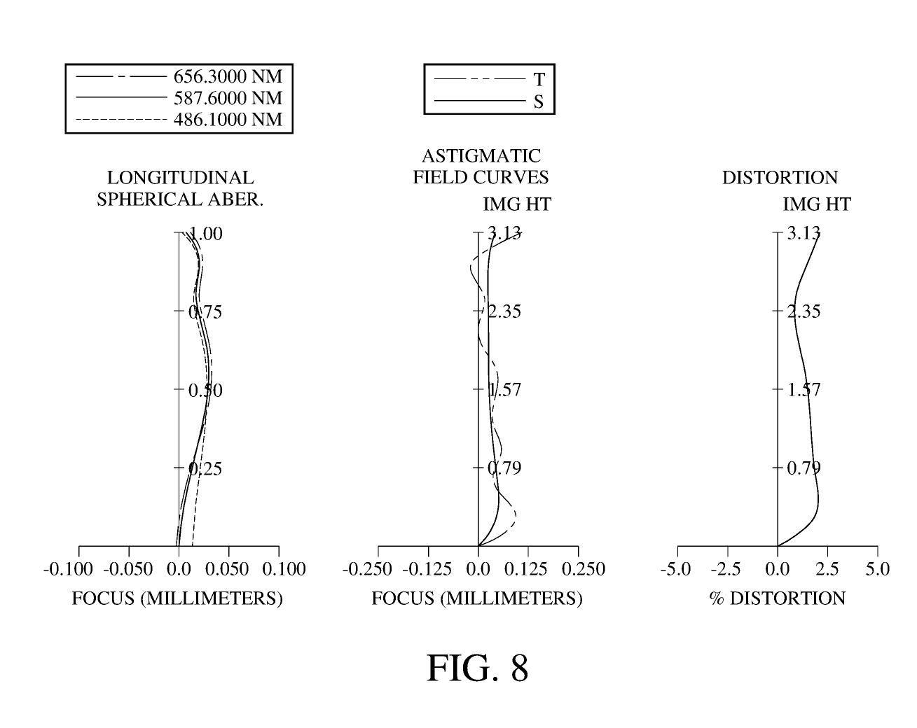

FIG. 7 is a schematic view of an image capturing unit according to the 4th embodiment of the present disclosure. FIG. 8 shows, in order from left to right, spherical aberration curves, astigmatic field curves and a distortion curve of the image capturing unit according to the 4th embodiment. In FIG. 7, the image capturing unit includes the optical imaging lens assembly (its reference numeral is omitted) of the present disclosure and an image sensor 490. The optical imaging lens assembly includes, in order from an object side to an image side, a first lens element 410, an aperture stop 400, a second lens element 420, a stop 401, a third lens element 430, a fourth lens element 440, a fifth lens element 450, a sixth lens element 460, an IR-cut filter 470 and an image surface 480. The optical imaging lens assembly includes six lens elements (410, 420, 430, 440, 450 and 460) with no additional lens element disposed between the first lens element 410 and the sixth lens element 460.

The first lens element 410 with negative refractive power has an object-side surface 411 being concave in a paraxial region thereof and an image-side surface 412 being concave in a paraxial region thereof. The first lens element 410 is made of plastic material and has the object-side surface 411 and the image-side surface 412 being both aspheric. The image-side surface 412 of the first lens element 410 has at least one critical point in an off-axial region thereof.

The second lens element 420 with positive refractive power has an object-side surface 421 being convex in a paraxial region thereof and an image-side surface 422 being convex in a paraxial region thereof. The second lens element 420 is made of glass and has the object-side surface 421 and the image-side surface 422 being both aspheric. The object-side surface 421 of the second lens element 420 has at least one critical point in an off-axial region thereof.

The third lens element 430 with negative refractive power has an object-side surface 431 being convex in a paraxial region thereof and an image-side surface 432 being concave in a paraxial region thereof. The third lens element 430 is made of plastic material and has the object-side surface 431 and the image-side surface 432 being both aspheric. The object-side surface 431 of the third lens element 430 has at least one critical point in an off-axial region thereof. The image-side surface 432 of the third lens element 430 has at least one convex critical point in an off-axial region thereof.

The fourth lens element 440 with negative refractive power has an object-side surface 441 being convex in a paraxial region thereof and an image-side surface 442 being concave in a paraxial region thereof. The fourth lens element 440 is made of plastic material and has the object-side surface 441 and the image-side surface 442 being both aspheric. The object-side surface 441 of the fourth lens element 440 has at least one concave critical point in an off-axial region thereof. The image-side surface 442 of the fourth lens element 440 has at least one convex critical point in an off-axial region thereof.

The fifth lens element 450 with positive refractive power has an object-side surface 451 being concave in a paraxial region thereof and an image-side surface 452 being convex in a paraxial region thereof. The fifth lens element 450 is made of plastic material and has the object-side surface 451 and the image-side surface 452 being both aspheric.

The sixth lens element 460 with negative refractive power has an object-side surface 461 being convex in a paraxial region thereof and an image-side surface 462 being concave in a paraxial region thereof. The sixth lens element 460 is made of plastic material and has the object-side surface 461 and the image-side surface 462 being both aspheric. The object-side surface 461 of the sixth lens element 460 has at least one critical point in an off-axial region thereof. The image-side surface 462 of the sixth lens element 460 has at least one convex critical point in an off-axial region thereof.

The IR-cut filter 470 is made of glass and located between the sixth lens element 460 and the image surface 480, and will not affect the focal length of the optical imaging lens assembly. The image sensor 490 is disposed on or near the image surface 480 of the optical imaging lens assembly.

The detailed optical data of the 4th embodiment are shown in Table 7 and the aspheric surface data are shown in Table 8 below.

TABLE 7
4th Embodiment
f = 2.76 mm, Fno = 1.64, HFOV = 48.0 deg.

| | | Curvature | | | | | | Focal |
|---|---|---|---|---|---|---|---|---|
| Surface # | | Radius | | Thickness | Material | Index | Abbe # | Length |
| 0 | Object | Plano | | Infinity | | | | |
| 1 | Lens 1 | −192.308 | (ASP) | 0.234 | Plastic | 1.545 | 56.0 | −14.07 |
| 2 | | 7.984 | (ASP) | 0.037 | | | | |
| 3 | Ape. Stop | Plano | | 0.025 | | | | |
| 4 | Lens 2 | 2.502 | (ASP) | 0.513 | Glass | 1.560 | 61.0 | 2.52 |
| 5 | | −3.001 | (ASP) | −0.140 | | | | |
| 6 | Stop | Plano | | 0.167 | | | | |
| 7 | Lens 3 | 30.963 | (ASP) | 0.220 | Plastic | 1.669 | 19.5 | −5.43 |
| 8 | | 3.241 | (ASP) | 0.330 | | | | |
| 9 | Lens 4 | 2.206 | (ASP) | 0.280 | Plastic | 1.544 | 56.0 | −137.91 |
| 10 | | 2.047 | (ASP) | 0.334 | | | | |
| 11 | Lens 5 | −2.114 | (ASP) | 0.750 | Plastic | 1.544 | 56.0 | 1.87 |
| 12 | | −0.773 | (ASP) | 0.025 | | | | |
| 13 | Lens 6 | 1.749 | (ASP) | 0.519 | Plastic | 1.669 | 19.5 | −2.71 |
| 14 | | 0.784 | (ASP) | 0.650 | | | | |

| | | | | | | | |
|---|---|---|---|---|---|---|---|
| 15 | IR-cut filter | Plano | 0.210 | Glass | 1.517 | 64.2 | — |
| 16 | | Plano | 0.546 | | | | |
| 17 | Image | Plano | — | | | | |

Note:
Reference wavelength is 587.6 nm (d-line).
An effective radius of the stop 401 (Surface 6) is 0.970 mm.

TABLE 8
Aspheric Coefficients

| Surface # | 1 | 2 | 4 | 5 | 7 | 8 |
|---|---|---|---|---|---|---|
| k= | −9.0000E+01 | 4.7523E+01 | −9.8302E+00 | −1.3065E+01 | −9.0000E+01 | 2.3731E+00 |
| A4= | −1.6374E−01 | −5.5999E−01 | −3.0280E−01 | 2.5302E−01 | 2.1501E−01 | −1.7678E−01 |
| A6= | 3.6925E−02 | 5.7099E−01 | 2.1495E−01 | −1.1501E+00 | −6.3975E−01 | 4.8187E−01 |
| A8= | −5.2323E−02 | −3.3061E−01 | 1.3518E−01 | 1.6136E+00 | 7.3583E−01 | −9.9631E−01 |
| A10= | 8.8004E−02 | 6.6885E−02 | −3.0081E−01 | −1.1765E+00 | −6.3108E−01 | 9.6643E−01 |
| A12= | −2.7378E−02 | 2.8020E−02 | 7.5144E−02 | 3.2619E−01 | 3.1977E−01 | −4.7883E−01 |
| A14= | — | — | — | — | −7.2540E−02 | 9.7950E−02 |
| Surface # | 9 | 10 | 11 | 12 | 13 | 14 |
| k= | −3.3766E+01 | −2.0161E+01 | −3.4310E+01 | −5.0231E+00 | −8.6305E−01 | −4.6190E+00 |
| A4= | −5.4757E−03 | 3.0145E−02 | −2.7717E−01 | −4.8249E−01 | −1.5085E−01 | −3.0522E−02 |
| A6= | −5.0352E−01 | −1.8366E−01 | 7.5431E−01 | 8.2907E−01 | 6.1385E−02 | −3.9103E−04 |
| A8= | 6.4038E−01 | 6.8463E−02 | −1.1242E+00 | −1.0769E+00 | −3.1114E−02 | 1.2680E−03 |
| A10= | −5.0161E−01 | 1.0530E−01 | 1.1328E+00 | 9.1875E−01 | 1.0140E−02 | −3.8990E−04 |
| A12= | 2.5428E−01 | −1.4762E−01 | −7.4482E−01 | −4.6753E−01 | −1.7062E−03 | 7.5067E−05 |
| A14= | −5.2115E−02 | 4.7896E−02 | 2.5994E−01 | 1.2975E−01 | 1.1593E−04 | −8.3013E−06 |
| A16= | — | — | −3.5180E−02 | −1.4973E−02 | −5.5367E−07 | 3.6490E−07 |

In the 4th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 4th embodiment, so an explanation in this regard will not be provided again.

Moreover, these parameters can be calculated from Table 7 and Table 8 as the following values and satisfy the following conditions:

4th Embodiment

| | | | |
|---|---|---|---|
| f [mm] | 2.76 | TL/ImgH | 1.50 |
| Fno | 1.64 | \|R1\|/f | 69.75 |
| HFOV [deg.] | 48.0 | \|R3/R4\| | 0.83 |
| (V4 + V6)/(V4 − V6) | 2.06 | f/f1 | −0.20 |
| V5/V6 | 2.88 | f/ImgH | 0.88 |
| V6 | 19.5 | f123/f456 | 1.48 |
| (CT1 + T12)/CT2 | 0.58 | FOV [deg.] | 96.0 |
| CT5/CT6 | 1.45 | Y62/R12 | 3.19 |
| (T34 + T45)/(T12 + T23 + T56) | 5.82 | Y62/Y11 | 2.13 |
| TD/EPD | 1.96 | — | — |

### 5th Embodiment

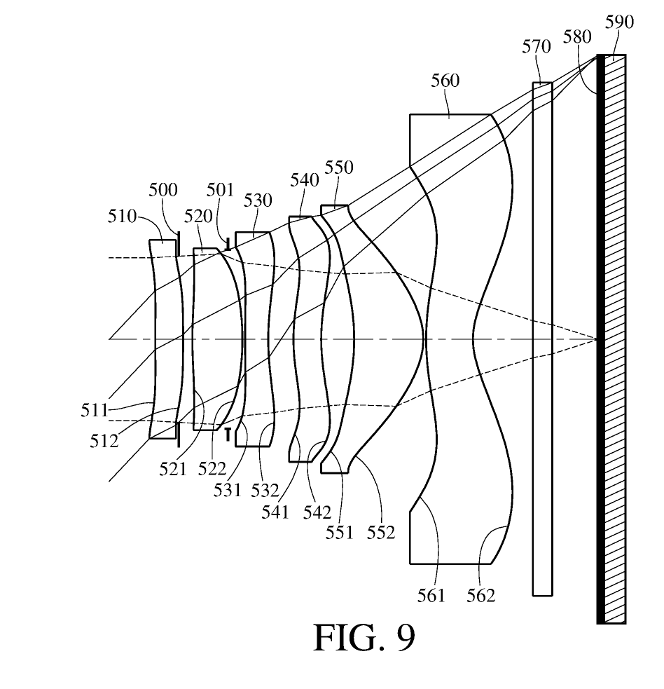

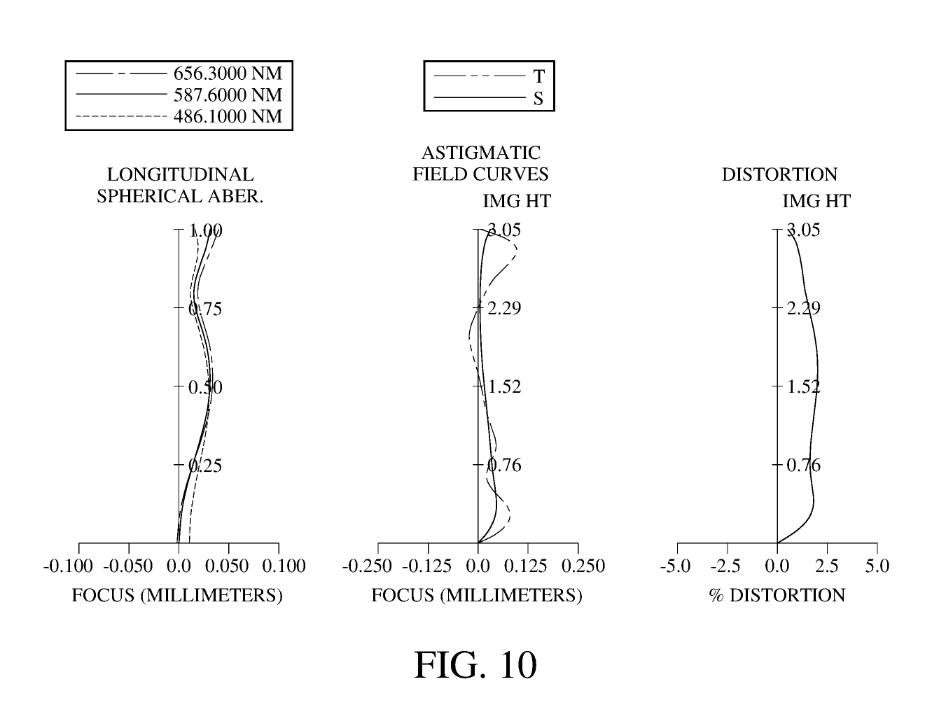

FIG. 9 is a schematic view of an image capturing unit according to the 5th embodiment of the present disclosure. FIG. 10 shows, in order from left to right, spherical aberration curves, astigmatic field curves and a distortion curve of the image capturing unit according to the 5th embodiment. In FIG. 9, the image capturing unit includes the optical imaging lens assembly (its reference numeral is omitted) of the present disclosure and an image sensor 590. The optical imaging lens assembly includes, in order from an object side to an image side, a first lens element 510, an aperture stop 500, a second lens element 520, a stop 501, a third lens element 530, a fourth lens element 540, a fifth lens element 550, a sixth lens element 560, an IR-cut filter 570 and an image surface 580. The optical imaging lens assembly includes six lens elements (510, 520, 530, 540, 550 and 560) with no additional lens element disposed between the first lens element 510 and the sixth lens element 560.

The first lens element 510 with positive refractive power has an object-side surface 511 being convex in a paraxial region thereof and an image-side surface 512 being convex in a paraxial region thereof. The first lens element 510 is made of plastic material and has the object-side surface 511 and the image-side surface 512 being both aspheric. The object-side surface 511 of the first lens element 510 has at least one concave critical point in an off-axial region thereof. The image-side surface 512 of the first lens element 510 has at least one critical point in an off-axial region thereof.

The second lens element 520 with positive refractive power has an object-side surface 521 being convex in a paraxial region thereof and an image-side surface 522 being convex in a paraxial region thereof. The second lens element 520 is made of plastic material and has the object-side surface 521 and the image-side surface 522 being both aspheric. The object-side surface 521 of the second lens element 520 has at least one critical point in an off-axial region thereof.

The third lens element 530 with negative refractive power has an object-side surface 531 being convex in a paraxial region thereof and an image-side surface 532 being concave in a paraxial region thereof. The third lens element 530 is made of plastic material and has the object-side surface 531 and the image-side surface 532 being both aspheric. The object-side surface 531 of the third lens element 530 has at least one critical point in an off-axial region thereof. The image-side surface 532 of the third lens element 530 has at least one convex critical point in an off-axial region thereof.

The fourth lens element 540 with positive refractive power has an object-side surface 541 being convex in a paraxial region thereof and an image-side surface 542 being concave in a paraxial region thereof. The fourth lens element 540 is made of plastic material and has the object-side surface 541 and the image-side surface 542 being both aspheric. The object-side surface 541 of the fourth lens element 540 has at least one concave critical point in an off-axial region thereof. The image-side surface 542 of the fourth lens element 540 has at least one convex critical point in an off-axial region thereof.

The fifth lens element 550 with positive refractive power has an object-side surface 551 being concave in a paraxial region thereof and an image-side surface 552 being convex in a paraxial region thereof. The fifth lens element 550 is made of plastic material and has the object-side surface 551 and the image-side surface 552 being both aspheric. The image-side surface 552 of the fifth lens element 550 has at least one critical point in an off-axial region thereof.

The sixth lens element 560 with negative refractive power has an object-side surface 561 being convex in a paraxial region thereof and an image-side surface 562 being concave in a paraxial region thereof. The sixth lens element 560 is made of plastic material and has the object-side surface 561 and the image-side surface 562 being both aspheric. The object-side surface 561 of the sixth lens element 560 has at least one critical point in an off-axial region thereof. The image-side surface 562 of the sixth lens element 560 has at least one convex critical point in an off-axial region thereof.

The IR-cut filter 570 is made of glass and located between the sixth lens element 560 and the image surface 580, and will not affect the focal length of the optical imaging lens assembly. The image sensor 590 is disposed on or near the image surface 580 of the optical imaging lens assembly.

The detailed optical data of the 5th embodiment are shown in Table 9 and the aspheric surface data are shown in Table 10 below.

TABLE 9
5th Embodiment
f = 2.84 mm, Fno = 1.61, HFOV = 46.7 deg.

| | | Curvature | | | | | | Focal |
|---|---|---|---|---|---|---|---|---|
| Surface # | | Radius | | Thickness | Material | Index | Abbe # | Length |
| 0 | Object | Plano | | Infinity | | | | |
| 1 | Lens 1 | 19.576 | (ASP) | 0.301 | Plastic | 1.566 | 37.4 | 31.51 |
| 2 | | −200.000 | (ASP) | −0.046 | | | | |
| 3 | Ape. Stop | Plano | | 0.147 | | | | |
| 4 | Lens 2 | 4.770 | (ASP) | 0.542 | Plastic | 1.544 | 56.0 | 3.24 |
| 5 | | −2.684 | (ASP) | −0.157 | | | | |
| 6 | Stop | Plano | | 0.187 | | | | |
| 7 | Lens 3 | 27.553 | (ASP) | 0.250 | Plastic | 1.669 | 19.5 | −4.58 |
| 8 | | 2.745 | (ASP) | 0.273 | | | | |
| 9 | Lens 4 | 1.953 | (ASP) | 0.301 | Plastic | 1.566 | 37.4 | 23.79 |
| 10 | | 2.157 | (ASP) | 0.357 | | | | |
| 11 | Lens 5 | −2.319 | (ASP) | 0.750 | Plastic | 1.566 | 37.4 | 1.49 |
| 12 | | −0.690 | (ASP) | 0.030 | | | | |
| 13 | Lens 6 | 2.637 | (ASP) | 0.507 | Plastic | 1.669 | 19.5 | −1.72 |
| 14 | | 0.740 | (ASP) | 0.650 | | | | |

| | | | | | | | |
|---|---|---|---|---|---|---|---|
| 15 | IR-cut filter | Plano | 0.210 | Glass | 1.517 | 64.2 | — |
| 16 | | Plano | 0.490 | | | | |
| 17 | Image | Plano | — | | | | |

Note:
Reference wavelength is 587.6 nm (d-line).
An effective radius of the stop 501 (Surface 6) is 0.970 mm.

TABLE 10
Aspheric Coefficients

| Surface # | 1 | 2 | 4 | 5 | 7 | 8 |
|---|---|---|---|---|---|---|
| k= | 9.0000E+01 | −9.0000E+01 | 1.0860E+00 | −5.5450E+00 | −9.0000E+01 | 1.9458E+00 |
| A4= | −1.2416E−01 | −2.4845E−01 | −1.7816E−01 | 6.0484E−02 | 4.1434E−02 | −2.0684E−01 |
| A6= | 2.5469E−02 | 6.5016E−02 | −1.9654E−02 | −5.7723E−01 | −4.2539E−01 | 2.9396E−01 |
| A8= | −3.9444E−02 | 4.2223E−01 | 4.7647E−01 | 8.4065E−01 | 7.1861E−01 | −5.0804E−01 |
| A10= | 7.5905E−02 | −6.5685E−01 | −6.6680E−01 | −6.4635E−01 | −9.3917E−01 | 4.0448E−01 |
| A12= | −2.3568E−02 | 3.6083E−01 | 2.9098E−01 | 1.9331E−01 | 6.9211E−01 | −1.5587E−01 |
| A14= | — | — | — | — | −2.1005E−01 | 2.3420E−02 |
| Surface # | 9 | 10 | 11 | 12 | 13 | 14 |
| k= | −1.0953E+01 | −1.9193E+01 | −3.3239E+01 | −4.6519E+00 | 1.5043E−01 | −5.5721E+00 |
| A4= | −1.1483E−01 | 3.6951E−02 | −2.8561E−01 | −4.4605E−01 | −7.9418E−02 | −1.3338E−02 |
| A6= | −4.4759E−02 | −1.4893E−01 | 7.4716E−01 | 8.5339E−01 | −7.4751E−03 | −2.0630E−02 |
| A8= | −7.7564E−03 | 6.3326E−02 | −1.1771E+00 | −1.2170E+00 | −3.5642E−03 | 1.1913E−02 |
| A10= | −3.3296E−02 | 3.3040E−02 | 1.2890E+00 | 1.1203E+00 | 6.1118E−03 | −3.4979E−03 |
| A12= | 6.6934E−02 | −6.7407E−02 | −9.0536E−01 | −6.1820E−01 | −2.7360E−03 | 5.8534E−04 |
| A14= | −2.0222E−02 | 2.3276E−02 | 3.3771E−01 | 1.8647E−01 | 5.9224E−04 | −5.2229E−05 |
| A16= | — | — | −4.9859E−02 | −2.3289E−02 | −5.0780E−05 | 1.9029E−06 |

In the 5th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 5th embodiment, so an explanation in this regard will not be provided again.

Moreover, these parameters can be calculated from Table 9 and Table 10 as the following values and satisfy the following conditions:

5th Embodiment

| | | | |
|---|---|---|---|
| f [mm] | 2.84 | TL/ImgH | 1.57 |
| Fno | 1.61 | \|R1\|/f | 6.89 |
| HFOV [deg.] | 46.7 | \|R3/R4\| | 1.78 |
| (V4 + V6)/(V4 − V6) | 3.16 | f/f1 | 0.09 |
| V5/V6 | 1.92 | f/ImgH | 0.93 |
| V6 | 19.5 | f123/f456 | 1.73 |
| (CT1 + T12)/CT2 | 0.74 | FOV [deg.] | 93.5 |
| CT5/CT6 | 1.48 | Y62/R12 | 3.29 |
| (T34 + T45)/(T12 + T23 + T56) | 3.91 | Y62/Y11 | 2.26 |
| TD/EPD | 1.95 | — | — |

### 6th Embodiment

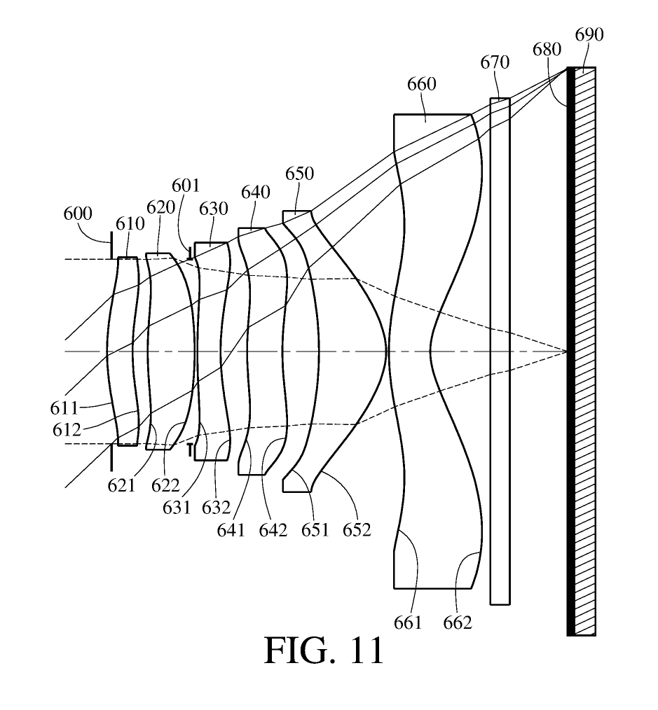

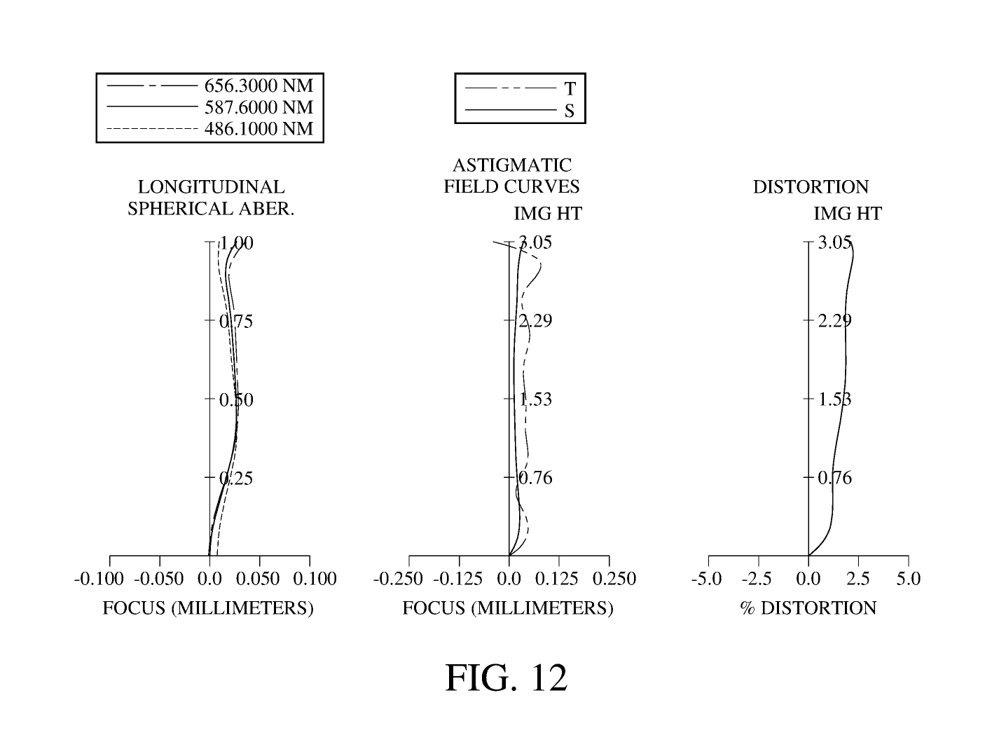

FIG. 11 is a schematic view of an image capturing unit according to the 6th embodiment of the present disclosure. FIG. 12 shows, in order from left to right, spherical aberration curves, astigmatic field curves and a distortion curve of the image capturing unit according to the 6th embodiment. In FIG. 11, the image capturing unit includes the optical imaging lens assembly (its reference numeral is omitted) of the present disclosure and an image sensor 690. The optical imaging lens assembly includes, in order from an object side to an image side, an aperture stop 600, a first lens element 610, a second lens element 620, a stop 601, a third lens element 630, a fourth lens element 640, a fifth lens element 650, a sixth lens element 660, an IR-cut filter 670 and an image surface 680. The optical imaging lens assembly includes six lens elements (610, 620, 630, 640, 650 and 660) with no additional lens element disposed between the first lens element 610 and the sixth lens element 660.

The first lens element 610 with positive refractive power has an object-side surface 611 being convex in a paraxial region thereof and an image-side surface 612 being concave in a paraxial region thereof. The first lens element 610 is made of plastic material and has the object-side surface 611 and the image-side surface 612 being both aspheric. The object-side surface 611 of the first lens element 610 has at least one concave critical point in an off-axial region thereof. The image-side surface 612 of the first lens element 610 has at least one critical point in an off-axial region thereof.

The second lens element 620 with positive refractive power has an object-side surface 621 being convex in a paraxial region thereof and an image-side surface 622 being convex in a paraxial region thereof. The second lens element 620 is made of plastic material and has the object-side surface 621 and the image-side surface 622 being both aspheric. The object-side surface 621 of the second lens element 620 has at least one critical point in an off-axial region thereof.

The third lens element 630 with negative refractive power has an object-side surface 631 being convex in a paraxial region thereof and an image-side surface 632 being concave in a paraxial region thereof. The third lens element 630 is made of plastic material and has the object-side surface 631 and the image-side surface 632 being both aspheric. The object-side surface 631 of the third lens element 630 has at least one critical point in an off-axial region thereof. The image-side surface 632 of the third lens element 630 has at least one convex critical point in an off-axial region thereof.

The fourth lens element 640 with negative refractive power has an object-side surface 641 being convex in a paraxial region thereof and an image-side surface 642 being concave in a paraxial region thereof. The fourth lens element 640 is made of plastic material and has the object-side surface 641 and the image-side surface 642 being both aspheric. The object-side surface 641 of the fourth lens element 640 has at least one concave critical point in an off-axial region thereof. The image-side surface 642 of the fourth lens element 640 has at least one convex critical point in an off-axial region thereof.

The fifth lens element 650 with positive refractive power has an object-side surface 651 being concave in a paraxial region thereof and an image-side surface 652 being convex in a paraxial region thereof. The fifth lens element 650 is made of plastic material and has the object-side surface 651 and the image-side surface 652 being both aspheric.

The sixth lens element 660 with negative refractive power has an object-side surface 661 being convex in a paraxial region thereof and an image-side surface 662 being concave in a paraxial region thereof. The sixth lens element 660 is made of plastic material and has the object-side surface 661 and the image-side surface 662 being both aspheric. The object-side surface 661 of the sixth lens element 660 has at least one critical point in an off-axial region thereof. The image-side surface 662 of the sixth lens element 660 has at least one convex critical point in an off-axial region thereof.

The IR-cut filter 670 is made of glass and located between the sixth lens element 660 and the image surface 680, and will not affect the focal length of the optical imaging lens assembly. The image sensor 690 is disposed on or near the image surface 680 of the optical imaging lens assembly.

The detailed optical data of the 6th embodiment are shown in Table 11 and the aspheric surface data are shown in Table 12 below.

TABLE 11
6th Embodiment
f = 3.15 mm, Fno = 1.58, HFOV = 43.3 deg.

| | | Curvature | | | | | | Focal |
|---|---|---|---|---|---|---|---|---|
| Surface # | | Radius | | Thickness | Material | Index | Abbe # | Length |
| 0 | Object | Plano | | Infinity | | | | |
| 1 | Ape. Stop | Plano | | −0.049 | | | | |
| 2 | Lens 1 | 2.406 | (ASP) | 0.276 | Plastic | 1.545 | 56.0 | 105.72 |
| 3 | | 2.409 | (ASP) | 0.163 | | | | |
| 4 | Lens 2 | 3.611 | (ASP) | 0.507 | Plastic | 1.544 | 56.0 | 3.56 |
| 5 | | −3.979 | (ASP) | −0.050 | | | | |
| 6 | Stop | Plano | | 0.080 | | | | |
| 7 | Lens 3 | 6.928 | (ASP) | 0.250 | Plastic | 1.671 | 19.5 | −6.09 |
| 8 | | 2.534 | (ASP) | 0.287 | | | | |
| 9 | Lens 4 | 3.009 | (ASP) | 0.381 | Plastic | 1.534 | 55.9 | −112.84 |
| 10 | | 2.740 | (ASP) | 0.395 | | | | |
| 11 | Lens 5 | −3.862 | (ASP) | 0.726 | Plastic | 1.544 | 56.0 | 1.46 |
| 12 | | −0.703 | (ASP) | 0.030 | | | | |
| 13 | Lens 6 | 2.467 | (ASP) | 0.446 | Plastic | 1.582 | 30.2 | −1.71 |
| 14 | | 0.663 | (ASP) | 0.650 | | | | |

| | | | | | | | |
|---|---|---|---|---|---|---|---|
| 15 | IR-cut filter | Plano | 0.210 | Glass | 1.517 | 64.2 | — |
| 16 | | Plano | 0.622 | | | | |
| 17 | Image | Plano | — | | | | |

Note:
Reference wavelength is 587.6 nm (d-line).
An effective radius of the stop 601 (Surface 6) is 1.000 mm.

TABLE 12
Aspheric Coefficients

| Surface # | 2 | 3 | 4 | 5 | 7 | 8 |
|---|---|---|---|---|---|---|
| k= | 3.3033E+00 | 3.8276E+00 | −2.4016E+01 | −4.2210E+00 | 1.9978E+01 | 2.1309E+00 |
| A4= | −9.8876E−02 | −1.8052E−01 | −5.1692E−02 | −5.4723E−03 | −3.9826E−02 | −1.6474E−01 |
| A6= | −4.1473E−02 | −6.0652E−02 | −1.0663E−01 | −2.2718E−01 | 1.3541E−03 | 2.2902E−01 |
| A8= | 4.2391E−02 | 2.9623E−02 | 2.3934E−02 | 2.3665E−01 | −1.7045E−01 | −3.8711E−01 |
| A10= | −8.9380E−02 | −9.4423E−02 | −2.4365E−02 | −1.3073E−01 | 2.4545E−01 | 3.1018E−01 |
| A12= | 3.0836E−02 | 6.0262E−02 | 4.3441E−02 | 2.5932E−02 | −1.7697E−01 | −1.4428E−01 |
| A14= | — | — | — | — | 3.8713E−02 | 2.9907E−02 |
| Surface # | 9 | 10 | 11 | 12 | 13 | 14 |
| k= | −5.3231E+01 | −5.8543E+01 | 4.7398E+00 | −4.5835E+00 | −1.1427E−01 | −4.6956E+00 |
| A4= | −3.2294E−02 | 7.5546E−02 | −7.4547E−02 | −3.4569E−01 | −7.2114E−02 | −1.7359E−02 |
| A6= | −3.0789E−01 | −3.6218E−01 | 3.2637E−01 | 6.4262E−01 | −7.9791E−03 | −1.0033E−02 |
| A8= | 5.1449E−01 | 4.6157E−01 | −6.4727E−01 | −9.1323E−01 | 9.0191E−03 | 6.3284E−03 |
| A10= | −5.2449E−01 | −3.5760E−01 | 7.9770E−01 | 8.3207E−01 | −2.8063E−03 | −1.8089E−03 |
| A12= | 2.8706E−01 | 1.2396E−01 | −5.7172E−01 | −4.3620E−01 | 4.5634E−04 | 2.8629E−04 |
| A14= | −5.8263E−02 | −1.2492E−02 | 2.0499E−01 | 1.1981E−01 | −3.7188E−05 | −2.3942E−05 |
| A16= | — | — | −2.8083E−02 | −1.3266E−02 | 1.0715E−06 | 8.2024E−07 |

In the 6th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 6th embodiment, so an explanation in this regard will not be provided again.

Moreover, these parameters can be calculated from Table 11 and Table 12 as the following values and satisfy the following conditions:

6th Embodiment

| | | | |
|---|---|---|---|
| f [mm] | 3.15 | TL/ImgH | 1.63 |
| Fno | 1.58 | \|R1\|/f | 0.76 |
| HFOV [deg.] | 43.3 | \|R3/R4\| | 0.91 |
| (V4 + V6)/(V4 − V6) | 3.36 | f/f1 | 0.03 |
| V5/V6 | 1.85 | f/ImgH | 1.03 |
| V6 | 30.2 | f123/f456 | 1.59 |
| (CT1 + T12)/CT2 | 0.87 | FOV [deg.] | 86.7 |
| CT5/CT6 | 1.63 | Y62/R12 | 3.87 |
| (T34 + T45)/(T12 + T23 + T56) | 3.06 | Y62/Y11 | 2.55 |
| TD/EPD | 1.75 | — | — |

### 7th Embodiment

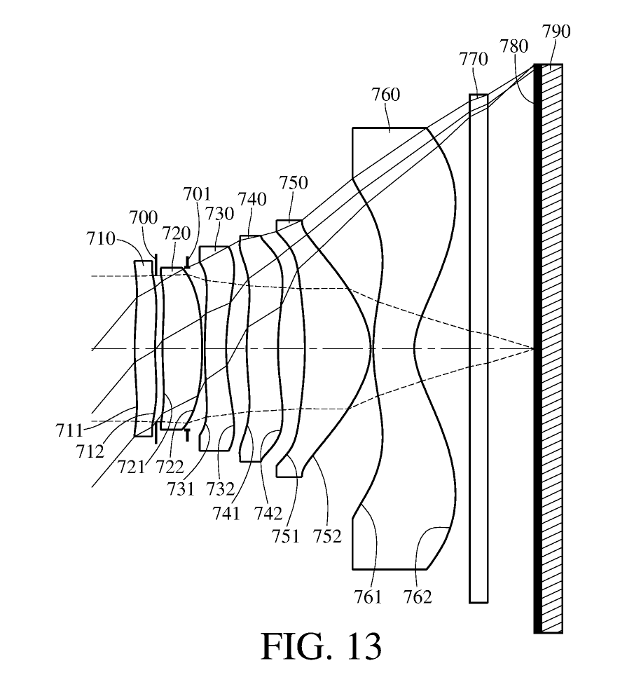

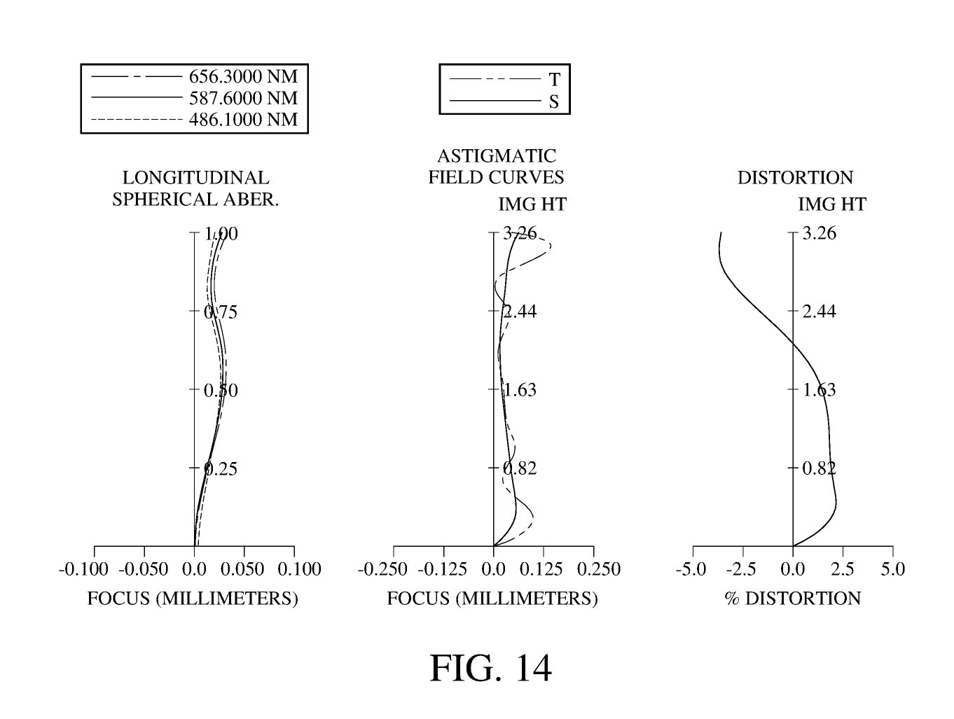

FIG. 13 is a schematic view of an image capturing unit according to the 7th embodiment of the present disclosure. FIG. 14 shows, in order from left to right, spherical aberration curves, astigmatic field curves and a distortion curve of the image capturing unit according to the 7th embodiment. In FIG. 13, the image capturing unit includes the optical imaging lens assembly (its reference numeral is omitted) of the present disclosure and an image sensor 790. The optical imaging lens assembly includes, in order from an object side to an image side, a first lens element 710, an aperture stop 700, a second lens element 720, a stop 701, a third lens element 730, a fourth lens element 740, a fifth lens element 750, a sixth lens element 760, an IR-cut filter 770 and an image surface 780. The optical imaging lens assembly includes six lens elements (710, 720, 730, 740, 750 and 760) with no additional lens element disposed between the first lens element 710 and the sixth lens element 760.

The first lens element 710 with negative refractive power has an object-side surface 711 being convex in a paraxial region thereof and an image-side surface 712 being concave in a paraxial region thereof. The first lens element 710 is made of plastic material and has the object-side surface 711 and the image-side surface 712 being both aspheric. The object-side surface 711 of the first lens element 710 has at least one concave critical point in an off-axial region thereof. The image-side surface 712 of the first lens element 710 has at least one critical point in an off-axial region thereof.

The second lens element 720 with positive refractive power has an object-side surface 721 being convex in a paraxial region thereof and an image-side surface 722 being convex in a paraxial region thereof. The second lens element 720 is made of plastic material and has the object-side surface 721 and the image-side surface 722 being both aspheric. The object-side surface 721 of the second lens element 720 has at least one critical point in an off-axial region thereof.

The third lens element 730 with negative refractive power has an object-side surface 731 being convex in a paraxial region thereof and an image-side surface 732 being concave in a paraxial region thereof. The third lens element 730 is made of plastic material and has the object-side surface 731 and the image-side surface 732 being both aspheric. The object-side surface 731 of the third lens element 730 has at least one critical point in an off-axial region thereof. The image-side surface 732 of the third lens element 730 has at least one convex critical point in an off-axial region thereof.

The fourth lens element 740 with positive refractive power has an object-side surface 741 being convex in a paraxial region thereof and an image-side surface 742 being concave in a paraxial region thereof. The fourth lens element 740 is made of plastic material and has the object-side surface 741 and the image-side surface 742 being both aspheric. The object-side surface 741 of the fourth lens element 740 has at least one concave critical point in an off-axial region thereof. The image-side surface 742 of the fourth lens element 740 has at least one convex critical point in an off-axial region thereof.

The fifth lens element 750 with positive refractive power has an object-side surface 751 being concave in a paraxial region thereof and an image-side surface 752 being convex in a paraxial region thereof. The fifth lens element 750 is made of plastic material and has the object-side surface 751 and the image-side surface 752 being both aspheric. The image-side surface 752 of the fifth lens element 750 has at least one critical point in an off-axial region thereof.

The sixth lens element 760 with negative refractive power has an object-side surface 761 being convex in a paraxial region thereof and an image-side surface 762 being concave in a paraxial region thereof. The sixth lens element 760 is made of plastic material and has the object-side surface 761 and the image-side surface 762 being both aspheric. The object-side surface 761 of the sixth lens element 760 has at least one critical point in an off-axial region thereof. The image-side surface 762 of the sixth lens element 760 has at least one convex critical point in an off-axial region thereof.

The IR-cut filter 770 is made of glass and located between the sixth lens element 760 and the image surface 780, and will not affect the focal length of the optical imaging lens assembly. The image sensor 790 is disposed on or near the image surface 780 of the optical imaging lens assembly.

The detailed optical data of the 7th embodiment are shown in Table 13 and the aspheric surface data are shown in Table 14 below.

TABLE 13
7th Embodiment
f = 2.83 mm, Fno = 1.67, HFOV = 49.9 deg.

| | | Curvature | | | | | | Focal |
|---|---|---|---|---|---|---|---|---|
| Surface # | | Radius | | Thickness | Material | Index | Abbe # | Length |
| 0 | Object | Plano | | Infinity | | | | |
| 1 | Lens 1 | 4.105 | (ASP) | 0.240 | Plastic | 1.544 | 56.0 | −133.02 |
| 2 | | 3.805 | (ASP) | 0.011 | | | | |
| 3 | Ape. Stop | Plano | | 0.075 | | | | |
| 4 | Lens 2 | 4.384 | (ASP) | 0.464 | Plastic | 1.544 | 56.0 | 3.61 |
| 5 | | −3.432 | (ASP) | −0.174 | | | | |
| 6 | Stop | Plano | | 0.204 | | | | |
| 7 | Lens 3 | 5.766 | (ASP) | 0.250 | Plastic | 1.671 | 19.5 | −6.55 |
| 8 | | 2.450 | (ASP) | 0.240 | | | | |
| 9 | Lens 4 | 2.761 | (ASP) | 0.367 | Plastic | 1.544 | 56.0 | 137.95 |
| 10 | | 2.732 | (ASP) | 0.314 | | | | |
| 11 | Lens 5 | −4.171 | (ASP) | 0.770 | Plastic | 1.544 | 56.0 | 1.51 |
| 12 | | −0.732 | (ASP) | 0.030 | | | | |
| 13 | Lens 6 | 2.218 | (ASP) | 0.479 | Plastic | 1.584 | 28.2 | −1.84 |
| 14 | | 0.668 | (ASP) | 0.650 | | | | |

| | | | | | | | |
|---|---|---|---|---|---|---|---|
| 15 | IR-cut filter | Plano | 0.210 | Glass | 1.517 | 64.2 | — |
| 16 | | Plano | 0.545 | | | | |
| 17 | Image | Plano | — | | | | |

Note:
Reference wavelength is 587.6 nm (d-line).
An effective radius of the stop 701 (Surface 6) is 0.950 mm.

TABLE 14
Aspheric Coefficients

| Surface # | 1 | 2 | 4 | 5 | 7 | 8 |
|---|---|---|---|---|---|---|
| k= | 2.3793E+00 | 1.1158E+01 | −4.6147E+01 | 3.9410E−01 | −1.7736E+01 | 1.9848E+00 |
| A4= | −1.4727E−01 | −3.0758E−01 | −9.6060E−02 | 6.5074E−03 | −2.2476E−02 | −2.1407E−01 |
| A6= | 1.5232E−02 | −2.8574E−01 | −5.4415E−01 | −3.5827E−01 | −1.3191E−01 | 3.6186E−01 |
| A8= | −5.3705E−02 | 9.9455E−01 | 1.3731E+00 | 5.5132E−01 | 2.5961E−01 | −6.1203E−01 |
| A10= | 5.2656E−02 | −1.0726E+00 | −1.3181E+00 | −4.8379E−01 | −5.2808E−01 | 4.8244E−01 |
| A12= | 3.8730E−03 | 4.6069E−01 | 4.3521E−01 | 1.4466E−01 | 4.0802E−01 | −2.0412E−01 |
| A14= | — | — | — | — | −1.1517E−01 | 3.6671E−02 |
| Surface # | 9 | 10 | 11 | 12 | 13 | 14 |
| k= | −5.6542E+01 | −6.6660E+01 | 4.8278E+00 | −5.2788E+00 | −3.2692E−01 | −4.2222E+00 |
| A4= | 9.0117E−03 | 1.1288E−01 | −2.1622E−02 | −4.7840E−01 | −1.4211E−01 | −5.0351E−02 |
| A6= | −4.9327E−01 | −4.2208E−01 | 3.3535E−01 | 9.9194E−01 | 2.3482E−02 | 6.2831E−03 |
| A8= | 8.3885E−01 | 4.8718E−01 | −7.4545E−01 | −1.4514E+00 | −1.2184E−02 | 9.1901E−04 |
| A10= | −7.9626E−01 | −3.3727E−01 | 9.2544E−01 | 1.3342E+00 | 9.0672E−03 | −6.2600E−04 |
| A12= | 3.9837E−01 | 8.8915E−02 | −6.7184E−01 | −7.1336E−01 | −3.5477E−03 | 1.1110E−04 |
| A14= | −7.5935E−02 | 2.3534E−05 | 2.4651E−01 | 2.0188E−01 | 6.7332E−04 | −8.5274E−06 |
| A16= | — | — | −3.4766E−02 | −2.3176E−02 | −4.9144E−05 | 2.4002E−07 |

In the 7th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 7th embodiment, so an explanation in this regard will not be provided again.

Moreover, these parameters can be calculated from Table 13 and Table 14 as the following values and satisfy the following conditions:

7th Embodiment

| | | | |
|---|---|---|---|
| f [mm] | 2.83 | TL/ImgH | 1.43 |
| Fno | 1.67 | \|R1\|/f | 1.45 |
| HFOV [deg.] | 49.9 | \|R3/R4\| | 1.28 |
| (V4 + V6)/(V4 − V6) | 3.03 | f/f1 | −0.02 |
| V5/V6 | 1.98 | f/ImgH | 0.87 |
| V6 | 28.2 | f123/f456 | 2.01 |
| (CT1 + T12)/CT2 | 0.70 | FOV [deg.] | 99.9 |
| CT5/CT6 | 1.61 | Y62/R12 | 3.87 |
| (T34 + T45)/(T12 + T23 + T56) | 3.79 | Y62/Y11 | 2.52 |
| TD/EPD | 1.93 | — | — |

### 8th Embodiment

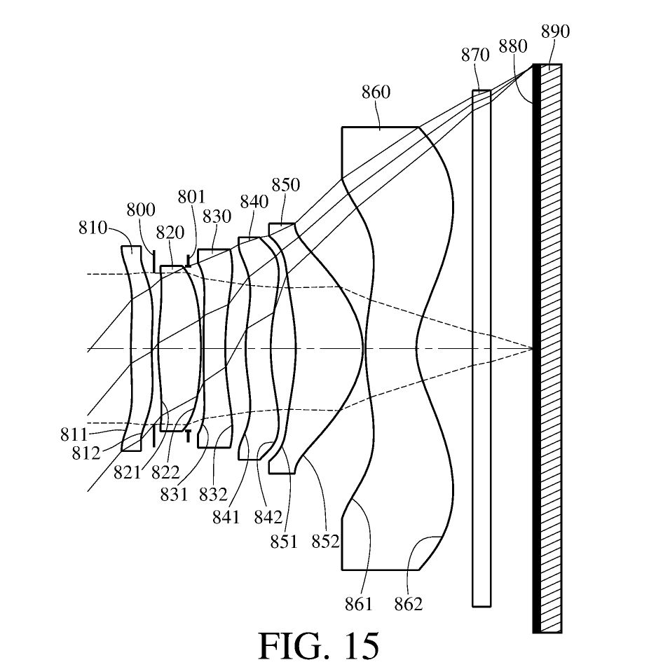

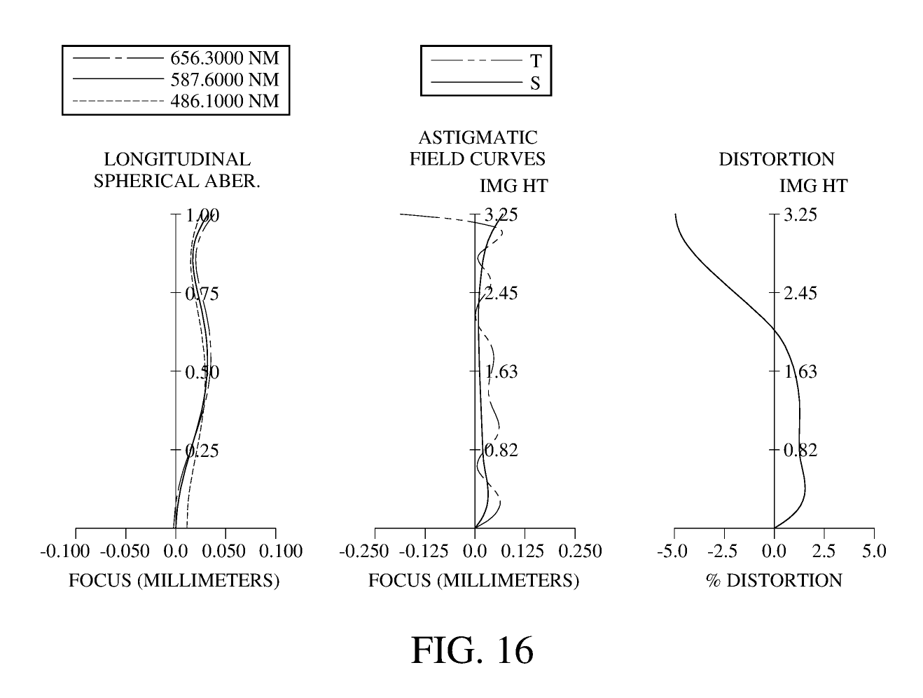

FIG. 15 is a schematic view of an image capturing unit according to the 8th embodiment of the present disclosure. FIG. 16 shows, in order from left to right, spherical aberration curves, astigmatic field curves and a distortion curve of the image capturing unit according to the 8th embodiment. In FIG. 15, the image capturing unit includes the optical imaging lens assembly (its reference numeral is omitted) of the present disclosure and an image sensor 890. The optical imaging lens assembly includes, in order from an object side to an image side, a first lens element 810, an aperture stop 800, a second lens element 820, a stop 801, a third lens element 830, a fourth lens element 840, a fifth lens element 850, a sixth lens element 860, an IR-cut filter 870 and an image surface 880. The optical imaging lens assembly includes six lens elements (810, 820, 830, 840, 850 and 860) with no additional lens element disposed between the first lens element 810 and the sixth lens element 860.

The first lens element 810 with negative refractive power has an object-side surface 811 being convex in a paraxial region thereof and an image-side surface 812 being concave in a paraxial region thereof. The first lens element 810 is made of plastic material and has the object-side surface 811 and the image-side surface 812 being both aspheric. The object-side surface 811 of the first lens element 810 has at least one concave critical point in an off-axial region thereof. The image-side surface 812 of the first lens element 810 has at least one critical point in an off-axial region thereof.

The second lens element 820 with positive refractive power has an object-side surface 821 being convex in a paraxial region thereof and an image-side surface 822 being convex in a paraxial region thereof. The second lens element 820 is made of plastic material and has the object-side surface 821 and the image-side surface 822 being both aspheric. The object-side surface 821 of the second lens element 820 has at least one critical point in an off-axial region thereof.

The third lens element 830 with negative refractive power has an object-side surface 831 being convex in a paraxial region thereof and an image-side surface 832 being concave in a paraxial region thereof. The third lens element 830 is made of plastic material and has the object-side surface 831 and the image-side surface 832 being both aspheric. The object-side surface 831 of the third lens element 830 has at least one critical point in an off-axial region thereof. The image-side surface 832 of the third lens element 830 has at least one convex critical point in an off-axial region thereof.

The fourth lens element 840 with positive refractive power has an object-side surface 841 being convex in a paraxial region thereof and an image-side surface 842 being concave in a paraxial region thereof. The fourth lens element 840 is made of plastic material and has the object-side surface 841 and the image-side surface 842 being both aspheric. The object-side surface 841 of the fourth lens element 840 has at least one concave critical point in an off-axial region thereof. The image-side surface 842 of the fourth lens element 840 has at least one convex critical point in an off-axial region thereof.

The fifth lens element 850 with positive refractive power has an object-side surface 851 being concave in a paraxial region thereof and an image-side surface 852 being convex in a paraxial region thereof. The fifth lens element 850 is made of plastic material and has the object-side surface 851 and the image-side surface 852 being both aspheric. The image-side surface 852 of the fifth lens element 850 has at least one critical point in an off-axial region thereof.

The sixth lens element 860 with negative refractive power has an object-side surface 861 being convex in a paraxial region thereof and an image-side surface 862 being concave in a paraxial region thereof. The sixth lens element 860 is made of plastic material and has the object-side surface 861 and the image-side surface 862 being both aspheric. The object-side surface 861 of the sixth lens element 860 has at least one critical point in an off-axial region thereof. The image-side surface 862 of the sixth lens element 860 has at least one convex critical point in an off-axial region thereof.

The IR-cut filter 870 is made of glass and located between the sixth lens element 860 and the image surface 880, and will not affect the focal length of the optical imaging lens assembly. The image sensor 890 is disposed on or near the image surface 880 of the optical imaging lens assembly.

The detailed optical data of the 8th embodiment are shown in Table 15 and the aspheric surface data are shown in Table 16 below.

TABLE 15
8th Embodiment
f = 2.87 mm, Fno = 1.67, HFOV = 49.9 deg.

| | | Curvature | | | | | | Focal |
|---|---|---|---|---|---|---|---|---|
| Surface # | | Radius | | Thickness | Material | Index | Abbe # | Length |
| 0 | Object | Plano | | Infinity | | | | |
| 1 | Lens 1 | 5.070 | (ASP) | 0.240 | Plastic | 1.545 | 56.0 | −20.69 |
| 2 | | 3.438 | (ASP) | 0.026 | | | | |
| 3 | Ape. Stop | Plano | | 0.049 | | | | |
| 4 | Lens 2 | 2.434 | (ASP) | 0.494 | Plastic | 1.544 | 56.0 | 2.58 |
| 5 | | −3.086 | (ASP) | −0.147 | | | | |
| 6 | Stop | Plano | | 0.177 | | | | |
| 7 | Lens 3 | 146.792 | (ASP) | 0.250 | Plastic | 1.669 | 19.5 | −4.65 |
| 8 | | 3.041 | (ASP) | 0.235 | | | | |
| 9 | Lens 4 | 1.939 | (ASP) | 0.290 | Plastic | 1.544 | 56.0 | 23.81 |
| 10 | | 2.160 | (ASP) | 0.289 | | | | |
| 11 | Lens 5 | −2.167 | (ASP) | 0.775 | Plastic | 1.544 | 56.0 | 1.88 |
| 12 | | −0.783 | (ASP) | 0.030 | | | | |
| 13 | Lens 6 | 2.324 | (ASP) | 0.586 | Plastic | 1.584 | 28.2 | −2.36 |
| 14 | | 0.786 | (ASP) | 0.650 | | | | |

| | | | | | | | |
|---|---|---|---|---|---|---|---|
| 15 | IR-cut filter | Plano | 0.210 | Glass | 1.517 | 64.2 | — |
| 16 | | Plano | 0.491 | | | | |
| 17 | Image | Plano | — | | | | |

Note:
Reference wavelength is 587.6 nm (d-line).
An effective radius of the stop 801 (Surface 6) is 0.950 mm.

TABLE 16
Aspheric Coefficients

| Surface # | 1 | 2 | 4 | 5 | 7 | 8 |
|---|---|---|---|---|---|---|
| k= | −9.0732E+00 | −9.4319E+00 | −1.0880E+01 | −1.4315E+01 | 9.0000E+01 | 2.4448E+00 |
| A4= | −1.9506E−01 | −4.9768E−01 | −2.3554E−01 | 2.4647E−01 | 2.1101E−01 | −1.8873E−01 |
| A6= | 5.7189E−02 | 1.1929E−01 | −1.8590E−01 | −1.1661E+00 | −5.5619E−01 | 5.2420E−01 |
| A8= | −1.8596E−01 | 4.9899E−01 | 8.5670E−01 | 1.7342E+00 | 4.4932E−01 | −1.0496E+00 |
| A10= | 2.2037E−01 | −6.1634E−01 | −7.3153E−01 | −1.3255E+00 | −9.5098E−02 | 1.0045E+00 |
| A12= | −6.3420E−02 | 2.5149E−01 | 1.1635E−01 | 3.7469E−01 | −2.1982E−01 | −4.9791E−01 |
| A14= | — | — | — | — | 1.3745E−01 | 1.0319E−01 |
| Surface # | 9 | 10 | 11 | 12 | 13 | 14 |
| k= | −2.2226E+01 | −1.5584E+01 | −5.6353E+01 | −5.4772E+00 | −4.9705E−01 | −4.6230E+00 |
| A4= | −5.3881E−03 | 3.7734E−02 | −3.1320E−01 | −5.1866E−01 | −1.4723E−01 | −5.1074E−02 |
| A6= | −4.7834E−01 | −1.5439E−01 | 1.0314E+00 | 9.5666E−01 | 2.7630E−02 | 9.1323E−03 |
| A8= | 6.0589E−01 | −5.2694E−02 | −1.7420E+00 | −1.2875E+00 | −3.9511E−03 | −7.5722E−04 |
| A10= | −4.9060E−01 | 2.8530E−01 | 1.8631E+00 | 1.1138E+00 | −3.0133E−03 | −2.8552E−04 |
| A12= | 2.5718E−01 | −2.6724E−01 | −1.2406E+00 | −5.7701E−01 | 1.9989E−03 | 9.2448E−05 |
| A14= | −5.3379E−02 | 7.6280E−02 | 4.4188E−01 | 1.6484E−01 | −3.8825E−04 | −1.0706E−05 |
| A16= | — | — | −6.3427E−02 | −1.9768E−02 | 2.4636E−05 | 4.6642E−07 |

In the 8th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 8th embodiment, so an explanation in this regard will not be provided again.

Moreover, these parameters can be calculated from Table 15 and Table 16 as the following values and satisfy the following conditions:

8th Embodiment

| | | | |
|---|---|---|---|
| f [mm] | 2.87 | TL/ImgH | 1.42 |
| Fno | 1.67 | \|R1\|/f | 1.76 |
| HFOV [deg.] | 49.9 | \|R3/R4\| | 0.79 |
| (V4 + V6)/(V4 − V6) | 3.03 | f/f1 | −0.14 |
| V5/V6 | 1.98 | f/ImgH | 0.88 |
| V6 | 28.2 | f123/f456 | 1.60 |
| (CT1 + T12)/CT2 | 0.64 | FOV [deg.] | 99.9 |
| CT5/CT6 | 1.32 | Y62/R12 | 3.25 |
| (T34 + T45)/(T12 + T23 + T56) | 3.88 | Y62/Y11 | 2.16 |
| TD/EPD | 1.91 | — | — |

### 9th Embodiment

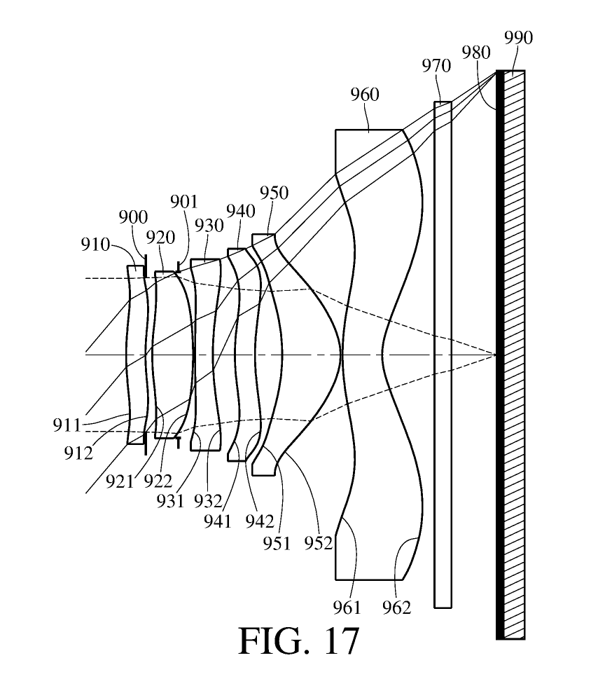

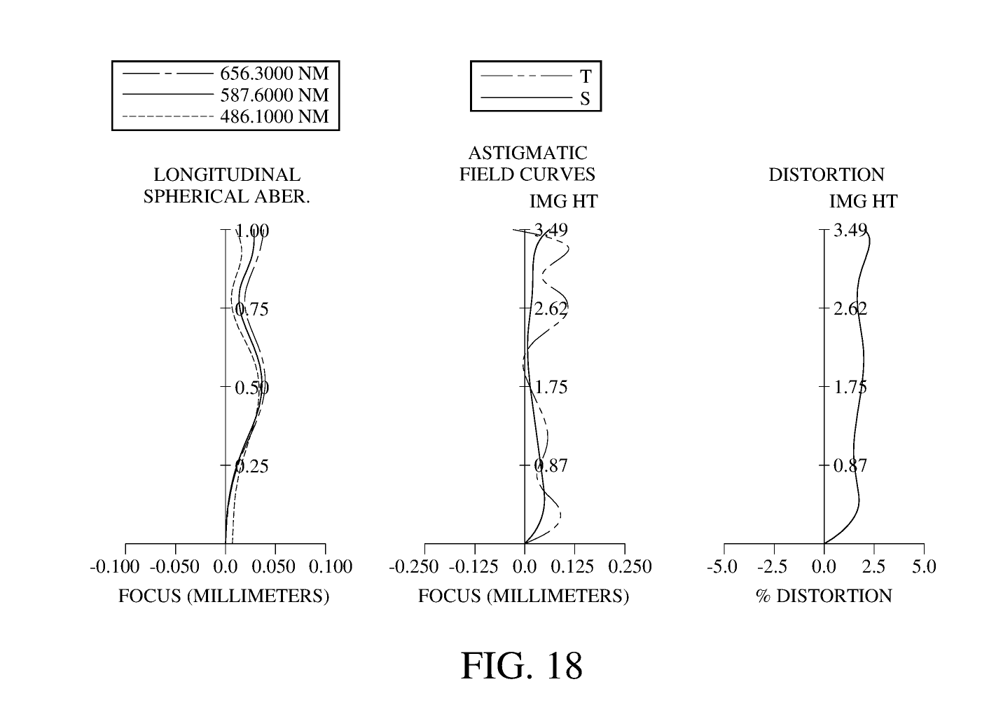

FIG. 17 is a schematic view of an image capturing unit according to the 9th embodiment of the present disclosure. FIG. 18 shows, in order from left to right, spherical aberration curves, astigmatic field curves and a distortion curve of the image capturing unit according to the 9th embodiment. In FIG. 17, the image capturing unit includes the optical imaging lens assembly (its reference numeral is omitted) of the present disclosure and an image sensor 990. The optical imaging lens assembly includes, in order from an object side to an image side, a first lens element 910, an aperture stop 900, a second lens element 920, a stop 901, a third lens element 930, a fourth lens element 940, a fifth lens element 950, a sixth lens element 960, an IR-cut filter 970 and an image surface 980. The optical imaging lens assembly includes six lens elements (910, 920, 930, 940, 950 and 960) with no additional lens element disposed between the first lens element 910 and the sixth lens element 960.

The first lens element 910 with negative refractive power has an object-side surface 911 being convex in a paraxial region thereof and an image-side surface 912 being concave in a paraxial region thereof. The first lens element 910 is made of plastic material and has the object-side surface 911 and the image-side surface 912 being both aspheric. The object-side surface 911 of the first lens element 910 has at least one concave critical point in an off-axial region thereof. The image-side surface 912 of the first lens element 910 has at least one critical point in an off-axial region thereof.

The second lens element 920 with positive refractive power has an object-side surface 921 being convex in a paraxial region thereof and an image-side surface 922 being convex in a paraxial region thereof. The second lens element 920 is made of plastic material and has the object-side surface 921 and the image-side surface 922 being both aspheric. The object-side surface 921 of the second lens element 920 has at least one critical point in an off-axial region thereof.

The third lens element 930 with negative refractive power has an object-side surface 931 being convex in a paraxial region thereof and an image-side surface 932 being concave in a paraxial region thereof. The third lens element 930 is made of plastic material and has the object-side surface 931 and the image-side surface 932 being both aspheric. The object-side surface 931 of the third lens element 930 has at least one critical point in an off-axial region thereof. The image-side surface 932 of the third lens element 930 has at least one convex critical point in an off-axial region thereof.

The fourth lens element 940 with positive refractive power has an object-side surface 941 being convex in a paraxial region thereof and an image-side surface 942 being concave in a paraxial region thereof. The fourth lens element 940 is made of plastic material and has the object-side surface 941 and the image-side surface 942 being both aspheric. The object-side surface 941 of the fourth lens element 940 has at least one concave critical point in an off-axial region thereof. The image-side surface 942 of the fourth lens element 940 has at least one convex critical point in an off-axial region thereof.

The fifth lens element 950 with positive refractive power has an object-side surface 951 being concave in a paraxial region thereof and an image-side surface 952 being convex in a paraxial region thereof. The fifth lens element 950 is made of plastic material and has the object-side surface 951 and the image-side surface 952 being both aspheric. The image-side surface 952 of the fifth lens element 950 has at least one critical point in an off-axial region thereof.

The sixth lens element 960 with negative refractive power has an object-side surface 961 being convex in a paraxial region thereof and an image-side surface 962 being concave in a paraxial region thereof. The sixth lens element 960 is made of plastic material and has the object-side surface 961 and the image-side surface 962 being both aspheric. The object-side surface 961 of the sixth lens element 960 has at least one critical point in an off-axial region thereof. The image-side surface 962 of the sixth lens element 960 has at least one convex critical point in an off-axial region thereof.

The IR-cut filter 970 is made of glass and located between the sixth lens element 960 and the image surface 980, and will not affect the focal length of the optical imaging lens assembly. The image sensor 990 is disposed on or near the image surface 980 of the optical imaging lens assembly.

The detailed optical data of the 9th embodiment are shown in Table 17 and the aspheric surface data are shown in Table 18 below.

TABLE 17
9th Embodiment
f = 2.89 mm, Fno = 1.52, HFOV = 49.8 deg.

| | | Curvature | | | | | | Focal |
|---|---|---|---|---|---|---|---|---|
| Surface # | | Radius | | Thickness | Material | Index | Abbe # | Length |
| 0 | Object | Plano | | Infinity | | | | |
| 1 | Lens 1 | 2.923 | (ASP) | 0.240 | Plastic | 1.545 | 56.0 | −35.37 |
| 2 | | 2.464 | (ASP) | 0.005 | | | | |
| 3 | Ape. Stop | Plano | | 0.079 | | | | |
| 4 | Lens 2 | 2.595 | (ASP) | 0.507 | Plastic | 1.544 | 56.0 | 2.98 |
| 5 | | −4.013 | (ASP) | −0.183 | | | | |
| 6 | Stop | Plano | | 0.208 | | | | |
| 7 | Lens 3 | 14.052 | (ASP) | 0.220 | Plastic | 1.669 | 19.5 | −5.57 |
| 8 | | 2.926 | (ASP) | 0.274 | | | | |
| 9 | Lens 4 | 2.190 | (ASP) | 0.250 | Plastic | 1.566 | 37.4 | 26.94 |
| 10 | | 2.451 | (ASP) | 0.338 | | | | |
| 11 | Lens 5 | −2.384 | (ASP) | 0.725 | Plastic | 1.566 | 37.4 | 1.49 |
| 12 | | −0.692 | (ASP) | 0.025 | | | | |
| 13 | Lens 6 | 2.680 | (ASP) | 0.492 | Plastic | 1.669 | 19.5 | −1.74 |
| 14 | | 0.751 | (ASP) | 0.650 | | | | |

| | | | | | | | |
|---|---|---|---|---|---|---|---|
| 15 | IR-cut filter | Plano | 0.210 | Glass | 1.517 | 64.2 | — |
| 16 | | Plano | 0.561 | | | | |
| 17 | Image | Plano | — | | | | |

Note:
Reference wavelength is 587.6 nm (d-line).
An effective radius of the stop 901 (Surface 6) is 1.030 mm.

TABLE 18
Aspheric Coefficients

| Surface # | 1 | 2 | 4 | 5 | 7 | 8 |
|---|---|---|---|---|---|---|
| k= | −9.3265E−01 | −1.4555E+00 | −7.4200E+00 | −1.5878E+01 | 3.5631E+01 | 1.8382E+00 |
| A4= | −1.5436E−01 | −2.5162E−01 | −3.4877E−02 | 3.5194E−02 | −3.6671E−02 | −2.2246E−01 |
| A6= | 3.1979E−02 | −4.8738E−01 | −7.0893E−01 | −3.4151E−01 | −2.3634E−02 | 4.8384E−01 |
| A8= | −1.3118E−01 | 1.1757E+00 | 1.4287E+00 | 4.2115E−01 | 2.6001E−01 | −6.5488E−01 |
| A10= | 1.4004E−01 | −9.9641E−01 | −1.1119E+00 | −3.0711E−01 | −7.0441E−01 | 4.0878E−01 |
| A12= | −3.3475E−02 | 3.4015E−01 | 2.9919E−01 | 8.3192E−02 | 5.9338E−01 | −1.1449E−01 |
| A14= | — | — | — | — | −1.5791E−01 | 9.6047E−03 |
| Surface # | 9 | 10 | 11 | 12 | 13 | 14 |
| k= | −1.8202E+01 | −4.1049E+01 | −2.3965E+01 | −4.3819E+00 | −2.1153E−02 | −5.5635E+00 |
| A4= | −1.1178E−01 | 4.1181E−02 | −3.3340E−01 | −3.8397E−01 | −5.6582E−02 | −1.2311E−02 |
| A6= | 1.3830E−01 | −6.4138E−02 | 8.4473E−01 | 6.0602E−01 | −1.5879E−02 | −9.1816E−03 |
| A8= | −5.2582E−01 | −1.9068E−01 | −1.4609E+00 | −7.2289E−01 | 1.1765E−02 | 4.6920E−03 |
| A10= | 6.5333E−01 | 3.5555E−01 | 1.7372E+00 | 5.3543E−01 | −4.5155E−03 | −1.1864E−03 |
| A12= | −3.5699E−01 | −2.5186E−01 | −1.2466E+00 | −2.2384E−01 | 1.0674E−03 | 1.6737E−04 |
| A14= | 7.4423E−02 | 6.2256E−02 | 4.6410E−01 | 5.0937E−02 | −1.3108E−04 | −1.2224E−05 |
| A16= | — | — | −6.8200E−02 | −5.0483E−03 | 6.2518E−06 | 3.5544E−07 |

In the 9th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 9th embodiment, so an explanation in this regard will not be provided again.

Moreover, these parameters can be calculated from Table 17 and Table 18 as the following values and satisfy the following conditions:

9th Embodiment

| | | | |
|---|---|---|---|
| f [mm] | 2.89 | TL/ImgH | 1.31 |
| Fno | 1.52 | \|R1\|/f | 1.01 |
| HFOV [deg.] | 49.8 | \|R3/R4\| | 0.65 |
| (V4 + V6)/(V4 − V6) | 3.16 | f/f1 | −0.08 |
| V5/V6 | 1.92 | f/ImgH | 0.82 |
| V6 | 19.5 | f123/f456 | 1.68 |
| (CT1 + T12)/CT2 | 0.64 | FOV [deg.] | 99.5 |
| CT5/CT6 | 1.47 | Y62/R12 | 3.72 |
| (T34 + T45)/(T12 + T23 + T56) | 4.57 | Y62/Y11 | 2.53 |
| TD/EPD | 1.67 | — | — |

### 10th Embodiment

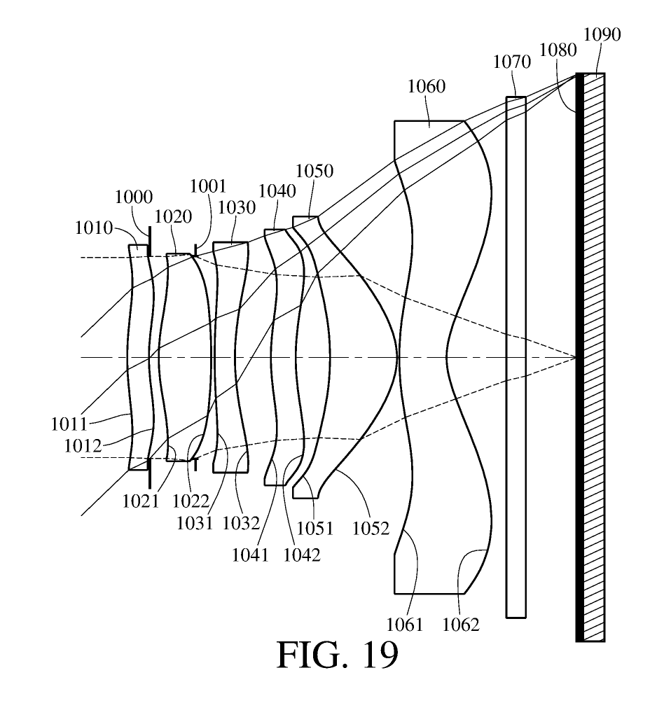

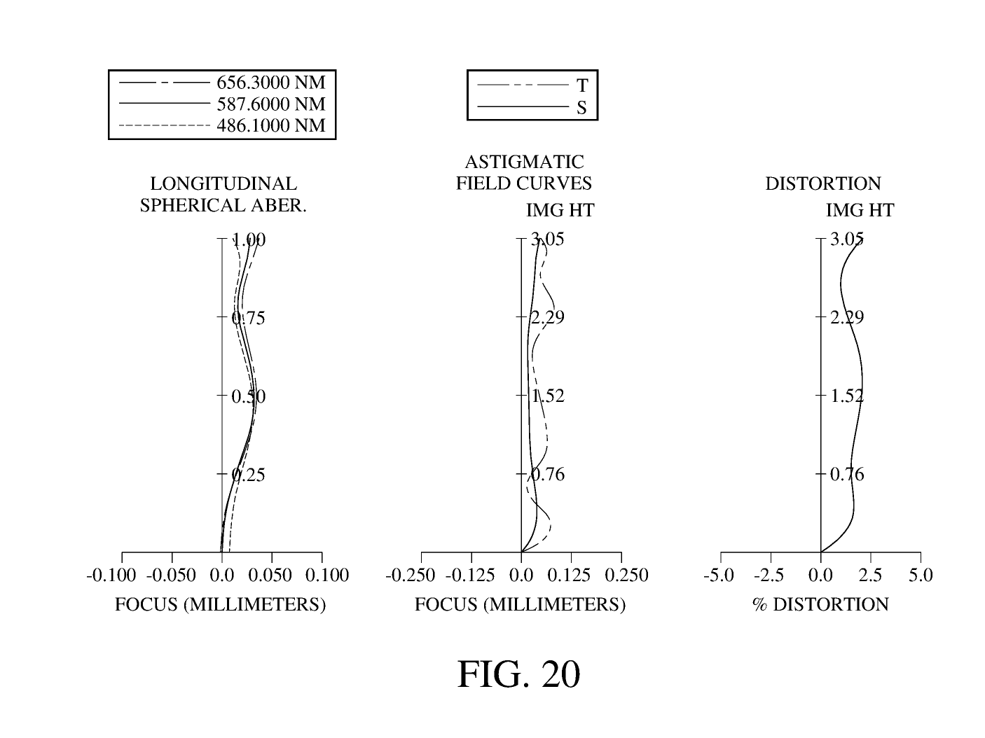

FIG. 19 is a schematic view of an image capturing unit according to the 10th embodiment of the present disclosure. FIG. 20 shows, in order from left to right, spherical aberration curves, astigmatic field curves and a distortion curve of the image capturing unit according to the 10th embodiment. In FIG. 19, the image capturing unit includes the optical imaging lens assembly (its reference numeral is omitted) of the present disclosure and an image sensor 1090. The optical imaging lens assembly includes, in order from an object side to an image side, a first lens element 1010, an aperture stop 1000, a second lens element 1020, a stop 1001, a third lens element 1030, a fourth lens element 1040, a fifth lens element 1050, a sixth lens element 1060, an IR-cut filter 1070 and an image surface 1080. The optical imaging lens assembly includes six lens elements (1010, 1020, 1030, 1040, 1050 and 1060) with no additional lens element disposed between the first lens element 1010 and the sixth lens element 1060.

The first lens element 1010 with negative refractive power has an object-side surface 1011 being convex in a paraxial region thereof and an image-side surface 1012 being concave in a paraxial region thereof. The first lens element 1010 is made of plastic material and has the object-side surface 1011 and the image-side surface 1012 being both aspheric. The object-side surface 1011 of the first lens element 1010 has at least one concave critical point in an off-axial region thereof. The image-side surface 1012 of the first lens element 1010 has at least one critical point in an off-axial region thereof.

The second lens element 1020 with positive refractive power has an object-side surface 1021 being convex in a paraxial region thereof and an image-side surface 1022 being convex in a paraxial region thereof. The second lens element 1020 is made of plastic material and has the object-side surface 1021 and the image-side surface 1022 being both aspheric. The object-side surface 1021 of the second lens element 1020 has at least one critical point in an off-axial region thereof.

The third lens element 1030 with negative refractive power has an object-side surface 1031 being convex in a paraxial region thereof and an image-side surface 1032 being concave in a paraxial region thereof. The third lens element 1030 is made of plastic material and has the object-side surface 1031 and the image-side surface 1032 being both aspheric. The object-side surface 1031 of the third lens element 1030 has at least one critical point in an off-axial region thereof. The image-side surface 1032 of the third lens element 1030 has at least one convex critical point in an off-axial region thereof.

The fourth lens element 1040 with positive refractive power has an object-side surface 1041 being convex in a paraxial region thereof and an image-side surface 1042 being concave in a paraxial region thereof. The fourth lens element 1040 is made of plastic material and has the object-side surface 1041 and the image-side surface 1042 being both aspheric. The object-side surface 1041 of the fourth lens element 1040 has at least one concave critical point in an off-axial region thereof. The image-side surface 1042 of the fourth lens element 1040 has at least one convex critical point in an off-axial region thereof.

The fifth lens element 1050 with positive refractive power has an object-side surface 1051 being concave in a paraxial region thereof and an image-side surface 1052 being convex in a paraxial region thereof. The fifth lens element 1050 is made of plastic material and has the object-side surface 1051 and the image-side surface 1052 being both aspheric.

The sixth lens element 1060 with negative refractive power has an object-side surface 1061 being convex in a paraxial region thereof and an image-side surface 1062 being concave in a paraxial region thereof. The sixth lens element 1060 is made of plastic material and has the object-side surface 1061 and the image-side surface 1062 being both aspheric. The object-side surface 1061 of the sixth lens element 1060 has at least one critical point in an off-axial region thereof. The image-side surface 1062 of the sixth lens element 1060 has at least one convex critical point in an off-axial region thereof.

The IR-cut filter 1070 is made of glass and located between the sixth lens element 1060 and the image surface 1080, and will not affect the focal length of the optical imaging lens assembly. The image sensor 1090 is disposed on or near the image surface 1080 of the optical imaging lens assembly.

The detailed optical data of the 10th embodiment are shown in Table 19 and the aspheric surface data are shown in Table 20 below.

TABLE 19
10th embodiment
f = 3.11 mm, Fno = 1.43, HFOV = 43.8 deg.

| Surface | | Curvature | | | | | | Focal |
|---|---|---|---|---|---|---|---|---|
| # | | Radius | | Thickness | Material | Index | Abbe # | Length |
| 0 | Object | Plano | | Infinity | | | | |
| 1 | Lens 1 | 2.847 | (ASP) | 0.235 | Plastic | 1.545 | 56.0 | −12.60 |
| 2 | | 1.954 | (ASP) | 0.011 | | | | |
| 3 | Ape. Stop | Plano | | 0.096 | | | | |
| 4 | Lens 2 | 1.937 | (ASP) | 0.569 | Plastic | 1.544 | 56.0 | 2.63 |
| 5 | | −4.906 | (ASP) | −0.170 | | | | |
| 6 | Stop | Plano | | 0.207 | | | | |
| 7 | Lens 3 | 6.429 | (ASP) | 0.220 | Plastic | 1.669 | 19.5 | −5.57 |
| 8 | | 2.327 | (ASP) | 0.390 | | | | |
| 9 | Lens 4 | 2.220 | (ASP) | 0.270 | Plastic | 1.544 | 56.0 | 55.85 |
| 10 | | 2.292 | (ASP) | 0.372 | | | | |
| 11 | Lens 5 | −2.841 | (ASP) | 0.727 | Plastic | 1.544 | 56.0 | 1.60 |
| 12 | | −0.725 | (ASP) | 0.025 | | | | |
| 13 | Lens 6 | 2.946 | (ASP) | 0.512 | Plastic | 1.582 | 30.2 | −1.89 |
| 14 | | 0.751 | (ASP) | 0.650 | | | | |

| | | | | | | | |
|---|---|---|---|---|---|---|---|
| 15 | IR-cut filter | Plano | 0.210 | Glass | 1.517 | 64.2 | — |
| 16 | | Plano | 0.550 | | | | |
| 17 | Image | Plano | — | | | | |

Note:
Reference wavelength is 587.6 nm (d-line).
An effective radius of the stop 1001 (Surface 6) is 1.100 mm.

TABLE 20
Aspheric Coefficients

| Surface # | 1 | 2 | 4 | 5 | 7 | 8 |
|---|---|---|---|---|---|---|
| k= | −2.1390E+00 | −3.0111E+00 | −5.6898E+00 | −4.6392E+01 | −7.2188E+00 | 1.5408E+00 |
| A4= | −1.5285E−01 | −2.8443E−01 | −3.8721E−02 | 5.2429E−02 | −7.3314E−02 | −2.4551E−01 |
| A6= | 5.9043E−02 | −1.1815E−01 | −3.4151E−01 | −2.6219E−01 | 1.5833E−01 | 4.4747E−01 |
| A8= | −6.8185E−02 | 3.8600E−01 | 4.9771E−01 | 2.2279E−01 | −2.6532E−01 | −5.9767E−01 |
| A10= | 4.1708E−02 | −2.8048E−01 | −2.6425E−01 | −9.7973E−02 | 1.7148E−01 | 4.0442E−01 |
| A12= | −5.4131E−03 | 7.7625E−02 | 3.8750E−02 | 1.2614E−02 | −5.9942E−02 | −1.4332E−01 |
| A14= | — | — | — | — | 1.2335E−02 | 2.0697E−02 |
| Surface # | 9 | 10 | 11 | 12 | 13 | 14 |
| k= | −1.2340E+01 | −3.5445E+01 | −4.1264E+01 | −4.8260E+00 | 1.2780E−01 | −5.2823E+00 |
| A4= | −9.5685E−02 | 1.0845E−01 | −2.8358E−01 | −3.9234E−01 | −2.3678E−02 | −8.5544E−03 |
| A6= | 2.3089E−03 | −2.7480E−01 | 7.3167E−01 | 7.1818E−01 | −5.4176E−02 | −1.6784E−02 |
| A8= | −1.0721E−01 | 2.0570E−01 | −1.1986E+00 | −9.4754E−01 | 3.5015E−02 | 8.8724E−03 |
| A10= | 1.2115E−01 | −5.6149E−02 | 1.2527E+00 | 7.7186E−01 | −1.2037E−02 | −2.4511E−03 |
| A12= | −5.0291E−02 | −2.5806E−02 | −7.7387E−01 | −3.6548E−01 | 2.4364E−03 | 3.7621E−04 |
| A14= | 8.5611E−03 | 1.2641E−02 | 2.4669E−01 | 9.3118E−02 | −2.6680E−04 | −3.0298E−05 |
| A16= | — | — | −3.0932E−02 | −9.8000E−03 | 1.2084E−05 | 1.0006E−06 |

In the 10th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 10th embodiment, so an explanation in this regard will not be provided again.

Moreover, these parameters can be calculated from Table 19 and Table 20 as the following values and satisfy the following conditions:

10th Embodiment

| | | | |
|---|---|---|---|
| f [mm] | 3.11 | TL/ImgH | 1.60 |
| Fno | 1.43 | \|R1\|/f | 0.92 |
| HFOV [deg.] | 43.8 | \|R3/R4\| | 0.39 |
| (V4 + V6)/(V4 − V6) | 3.35 | f/f1 | −0.25 |
| V5/V6 | 1.85 | f/ImgH | 1.02 |
| V6 | 30.2 | f123/f456 | 1.53 |
| (CT1 + T12)/CT2 | 0.60 | FOV [deg.] | 87.5 |
| CT5/CT6 | 1.42 | Y62/R12 | 3.42 |
| (T34 + T45)/(T12 + T23 + T56) | 4.51 | Y62/Y11 | 2.10 |
| TD/EPD | 1.60 | — | — |

### 11th Embodiment

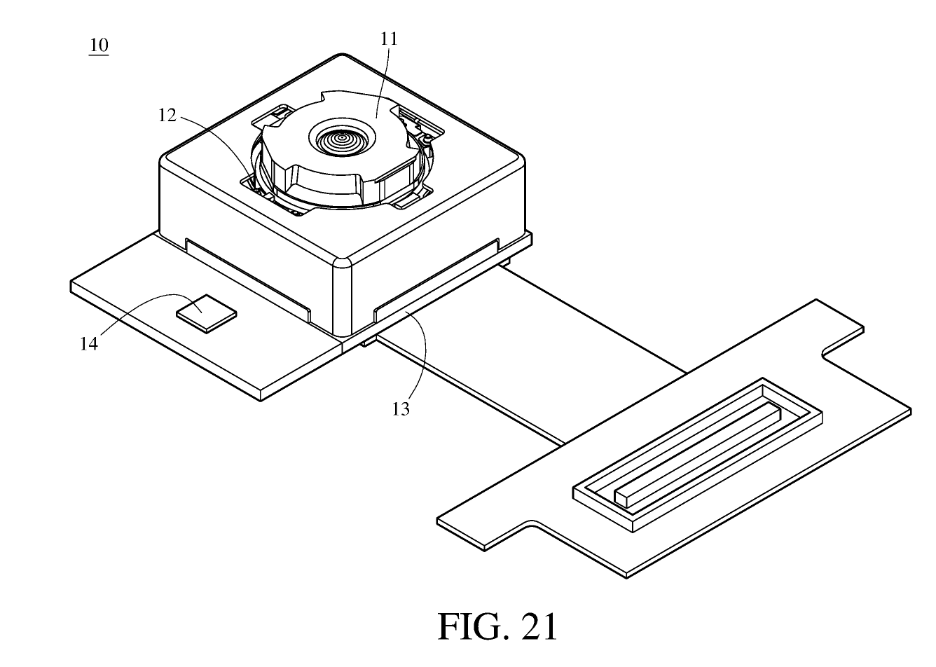

FIG. 21 is a perspective view of an image capturing unit according to the 11th embodiment of the present disclosure. In this embodiment, an image capturing unit 10 is a camera module including a lens unit 11, a driving device 12, an image sensor 13 and an image stabilizer 14. The lens unit 11 includes the optical imaging lens assembly disclosed in the 1st embodiment, a barrel and a holder member (their reference numerals are omitted) for holding the optical imaging lens assembly. The external light converges into the lens unit 11 of the image capturing unit 10 to generate an image, and the lens unit 11 along with the driving device 12 is utilized for image focusing on the image sensor 13, and the image is able to be digitally transmitted to an electronic component.

The driving device 12 can have auto-focus functionality, and different driving configurations can be through the use of voice coil motors (VCM), micro electro-mechanical systems (MEMS), piezoelectric systems, or shape memory alloy materials. The driving device 12 is favorable for the lens unit 11 to obtain a better imaging position, so that a clear image of the imaged object can be captured by the lens unit 11 with different object distances. The image sensor 13 (for example, CCD or CMOS), which can be featured with high photosensitivity and low noise, is disposed on the image surface of the optical imaging lens assembly to provide higher image quality.

The image stabilizer 14, such as an accelerometer, a gyroscope and a Hall effect sensor, is configured to work with the driving device 12 to provide optical image stabilization (01S). The driving device 12 working with the image stabilizer 14 is favorable for compensating for pan and tilt of the lens unit 11 to reduce blurring associated with motion during exposure. In some cases, the compensation can be provided by electronic image stabilization (EIS) with image processing software, thereby improving image quality while in motion or low-light conditions.

### 12th Embodiment

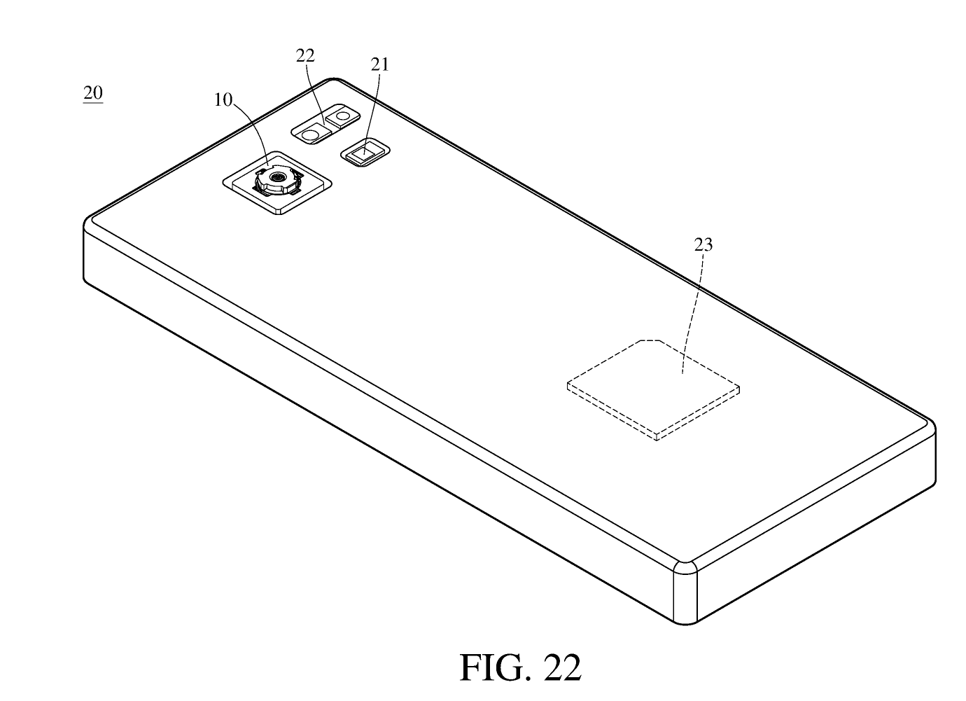

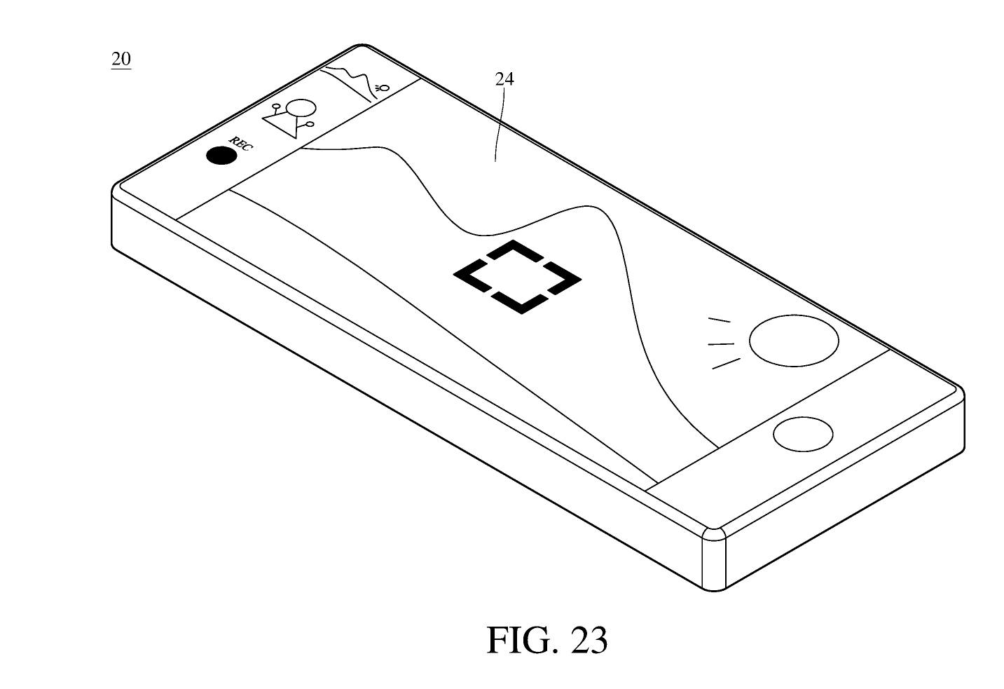

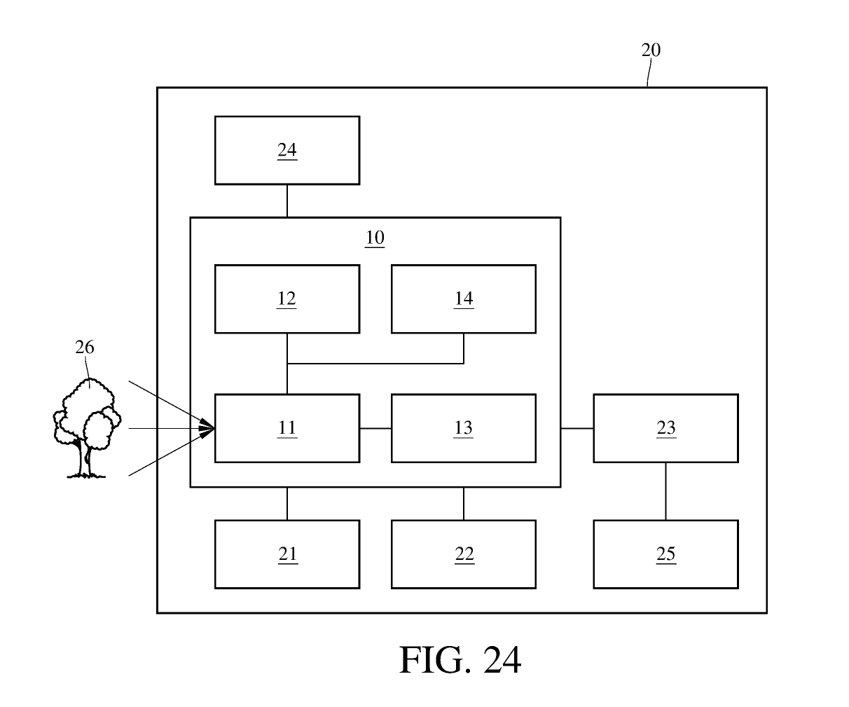

FIG. 22 is one perspective view of an electronic device according to the 12th embodiment of the present disclosure. FIG. 23 is another perspective view of the electronic device in FIG. 22. FIG. 24 is a block diagram of the electronic device in FIG. 22. In this embodiment, an electronic device 20 is a smart phone including the image capturing unit 10 disclosed in the 11th embodiment, a flash module 21, a focus assist module 22, an image signal processor 23, a user interface 24 and an image software processor 25. In this embodiment, the electronic device 20 includes one image capturing unit 10, but the disclosure is not limited thereto. In some cases, the electronic device 20 can include multiple image capturing units 10, or the electronic device 20 further includes another different image capturing unit.

When a user captures the images of an object 26 through the user interface 24, the light rays converge in the image capturing unit 10 to generate images, and the flash module 21 is activated for light supplement. The focus assist module 22 detects the object distance of the imaged object 26 to achieve quick focusing. The image signal processor 23 is configured to optimize the captured image to improve image quality. The light beam emitted from the focus assist module 22 can be infrared or laser. The user interface 24 can be a touch screen or a physical button. The user is able to interact with the user interface 24 and the image software processor 25 having multiple functions to capture images and complete image processing.

The smart phone in this embodiment is only exemplary for showing the image capturing unit 10 of the present disclosure installed in an electronic device, and the present disclosure is not limited thereto. The image capturing unit 10 can be optionally applied to optical systems with a movable focus. Furthermore, the optical imaging lens assembly of the image capturing unit 10 is featured with good capability in aberration corrections and high image quality, and can be applied to 3D (three-dimensional) image capturing applications, in products such as digital cameras, mobile devices, digital tablets, smart televisions, network surveillance devices, dashboard cameras, vehicle backup cameras, multiple camera devices, motion sensing input devices, wearable devices and other electronic imaging devices.

The foregoing description, for the purpose of explanation, has been described with reference to specific embodiments. It is to be noted that TABLES 1-20 show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An optical imaging lens assembly comprising six lens elements, the six lens elements being, in order from an object side to an image side:
a first lens element;
a second lens element having positive refractive power;
a third lens element having negative refractive power;
a fourth lens element;
a fifth lens element with positive refractive power having an image-side surface being convex in a paraxial region thereof; and
a sixth lens element having negative refractive power;
wherein at least one surface among object-side surfaces and image-side surfaces of the six lens elements has at least one critical point in an off-axial region thereof and is aspheric, an Abbe number of the sixth lens element is V6, an axial distance between the first lens element and the second lens element is T12, an axial distance between the second lens element and the third lens element is T23, an axial distance between the third lens element and the fourth lens element is T34, an axial distance between the fourth lens element and the fifth lens element is T45, an axial distance between the fifth lens element and the sixth lens element is T56, an axial distance between an object-side surface of the first lens element and an image-side surface of the sixth lens element is TD, an entrance pupil diameter of the optical imaging lens assembly is EPD, and the following conditions are satisfied:
V6<41;
1.5<(T34+T45)/(T12+T23+T56)<50; and
0.8<TD/EPD<2.5.

2. The optical imaging lens assembly of claim 1, wherein the axial distance between the first lens element and the second lens element is T12, the axial distance between the second lens element and the third lens element is T23, the axial distance between the third lens element and the fourth lens element is T34, the axial distance between the fourth lens element and the fifth lens element is T45, the axial distance between the fifth lens element and the sixth lens element is T56, and the following condition is satisfied:
2.3<(T34+T45)/(T12+T23+T56)<30.

3. The optical imaging lens assembly of claim 1, wherein the axial distance between the object-side surface of the first lens element and the image-side surface of the sixth lens element is TD, the entrance pupil diameter of the optical imaging lens assembly is EPD, and the following condition is satisfied:
1.0<TD/EPD<2.1.

4. The optical imaging lens assembly of claim 1, wherein an Abbe number of the fourth lens element is V4, the Abbe number of the sixth lens element is V6, and the following condition is satisfied:
1.2<(V4+V6)/(V4-V6)<22.

5. The optical imaging lens assembly of claim 1, wherein an Abbe number of the fifth lens element is V5, the Abbe number of the sixth lens element is V6, and the following condition is satisfied:
1.2<V5/V6<5.0.

6. The optical imaging lens assembly of claim 1, wherein the object-side surface of the first lens element is convex in a paraxial region thereof, and the object-side surface of the first lens element has at least one concave critical point in an off-axial region thereof.

7. An optical imaging lens assembly comprising six lens elements, the six lens elements being, in order from an object side to an image side:
a first lens element;
a second lens element having positive refractive power;
a third lens element having negative refractive power;
a fourth lens element having an object-side surface being convex in a paraxial region thereof;
a fifth lens element with positive refractive power having an object-side surface being concave in a paraxial region thereof and an image-side surface being convex in a paraxial region thereof; and
a sixth lens element having negative refractive power;
wherein at least one surface among object-side surfaces and image-side surfaces of the six lens elements has at least one critical point in an off-axial region thereof and is aspheric, an Abbe number of the sixth lens element is V6, an axial distance between the first lens element and the second lens element is T12, an axial distance between the second lens element and the third lens element is T23, an axial distance between the third lens element and the fourth lens element is T34, an axial distance between the fourth lens element and the fifth lens element is T45, an axial distance between the fifth lens element and the sixth lens element is T56, and the following conditions are satisfied:
V6<41; and
2.3<(T34+T45)/(T12+T23+T56)<30.

8. The optical imaging lens assembly of claim 7, wherein the axial distance between the first lens element and the second lens element is T12, the axial distance between the second lens element and the third lens element is T23, the axial distance between the third lens element and the fourth lens element is T34, the axial distance between the fourth lens element and the fifth lens element is T45, the axial distance between the fifth lens element and the sixth lens element is T56, and the following condition is satisfied:
2.6<(T34+T45)/(T12+T23+T56)<20.

9. The optical imaging lens assembly of claim 7, wherein the first lens element has negative refractive power.

10. The optical imaging lens assembly of claim 9, wherein an axial distance between an object-side surface of the first lens element and an image surface is TL, a maximum image height of the optical imaging lens assembly is ImgH, a maximum field of view of the optical imaging lens assembly is FOV, and the following conditions are satisfied:
0.80<TL/ImgH<1.75; and
85[deg.]<FOV<150[deg.].

11. The optical imaging lens assembly of claim 9, wherein a composite focal length of the first lens element, the second lens element and the third lens element is f123, a composite focal length of the fourth lens element, the fifth lens element and the sixth lens element is f456, and the following condition is satisfied:
1.10<f123/f456.

12. The optical imaging lens assembly of claim 7, wherein an axial distance between an object-side surface of the first lens element and an image-side surface of the sixth lens element is TD, an entrance pupil diameter of the optical imaging lens assembly is EPD, an f-number of the optical imaging lens assembly is Fno, and the following conditions are satisfied:
0.8<TD/EPD<2.5; and
1.00<Fno<1.90.

13. The optical imaging lens assembly of claim 7, wherein an Abbe number of the fourth lens element is V4, the Abbe number of the sixth lens element is V6, and the following condition is satisfied:
1.2<(V4+V6)/(V4-V6)<22.

14. The optical imaging lens assembly of claim 7, wherein an Abbe number of the fifth lens element is V5, the Abbe number of the sixth lens element is V6, and the following condition is satisfied:
1.2<V5/V6<5.0.

15. The optical imaging lens assembly of claim 7, wherein a central thickness of the first lens element is CT1, a central thickness of the second lens element is CT2, the axial distance between the first lens element and the second lens element is T12, and the following condition is satisfied:
(CT1+T12)/CT2<1.0.

16. The optical imaging lens assembly of claim 7, wherein a central thickness of the fifth lens element is CT5, a central thickness of the sixth lens element is CT6, and the following condition is satisfied:
1.1<CT5/CT6<2.0.

17. The optical imaging lens assembly of claim 7, wherein a curvature radius of an object-side surface of the first lens element is R1, a focal length of the optical imaging lens assembly is f, and the following condition is satisfied:
0.60<|R1|/f.

18. The optical imaging lens assembly of claim 7, wherein a focal length of the optical imaging lens assembly is f, a focal length of the first lens element is f1, and the following condition is satisfied:
−0.60<f/f1<0.50.

19. The optical imaging lens assembly of claim 7, wherein the first lens element has an object-side surface being convex in a paraxial region thereof, and the object-side surface of the first lens element has at least one concave critical point in an off-axial region thereof.

20. The optical imaging lens assembly of claim 7, wherein the second lens element has an object-side surface being convex in a paraxial region thereof, a curvature radius of the object-side surface of the second lens element is R3, a curvature radius of an image-side surface of the second lens element is R4, and the following condition is satisfied:

|R3/R4|<4.0.

21. An optical imaging lens assembly comprising six lens elements, the six lens elements being, in order from an object side to an image side:
a first lens element having negative refractive power;
a second lens element having positive refractive power;
a third lens element having negative refractive power;
a fourth lens element;
a fifth lens element having positive refractive power; and
a sixth lens element having negative refractive power;
wherein at least one surface among object-side surfaces and image-side surfaces of the six lens elements has at least one critical point in an off-axial region thereof and is aspheric, an Abbe number of the sixth lens element is V6, an axial distance between an object-side surface of the first lens element and an image-side surface of the sixth lens element is TD, an entrance pupil diameter of the optical imaging lens assembly is EPD, and the following conditions are satisfied:
V6<41; and
0.8<TD/EPD<2.5.

22. The optical imaging lens assembly of claim 21, wherein the axial distance between the object-side surface of the first lens element and the image-side surface of the sixth lens element is TD, the entrance pupil diameter of the optical imaging lens assembly is EPD, and the following condition is satisfied:
1.0<TD/EPD<2.1.

23. The optical imaging lens assembly of claim 21, wherein an axial distance between the first lens element and the second lens element is T12, an axial distance between the second lens element and the third lens element is T23, an axial distance between the third lens element and the fourth lens element is T34, an axial distance between the fourth lens element and the fifth lens element is T45, an axial distance between the fifth lens element and the sixth lens element is T56, and the following condition is satisfied:
2.3<(T34+T45)/(T12+T23+T56)<30.

24. The optical imaging lens assembly of claim 21, wherein an Abbe number of the fourth lens element is V4, the Abbe number of the sixth lens element is V6, and the following condition is satisfied:
1.2<(V4+V6)/(V4-V6)<22.

25. The optical imaging lens assembly of claim 21, wherein a central thickness of the first lens element is CT1, a central thickness of the second lens element is CT2, an axial distance between the first lens element and the second lens element is T12, and the following condition is satisfied:
(CT1+T12)/CT2<1.0.

26. The optical imaging lens assembly of claim 21, wherein a central thickness of the fifth lens element is CT5, a central thickness of the sixth lens element is CT6, and the following condition is satisfied:
1.1<CT5/CT6<2.0.

27. The optical imaging lens assembly of claim 21, wherein a curvature radius of the object-side surface of the first lens element is R1, a focal length of the optical imaging lens assembly is f, and the following condition is satisfied:
0.60<|R1|/f.

28. The optical imaging lens assembly of claim 21, wherein a composite focal length of the first lens element, the second lens element and the third lens element is f123, a composite focal length of the fourth lens element, the fifth lens element and the sixth lens element is f456, and the following condition is satisfied:
1.10<f123/f456.

29. The optical imaging lens assembly of claim 21, wherein at least three of the six lens elements of the optical imaging lens assembly each have at least one critical point in an off-axial region thereof, a focal length of the optical imaging lens assembly is f, a maximum image height of the optical imaging lens assembly is ImgH, an f-number of the optical imaging lens assembly is Fno, an axial distance between the object-side surface of the first lens element and an image surface is TL, and the following conditions are satisfied:
0.55<f/ImgH<1.1;
1.00<Fno<1.90; and
0.80<TL/ImgH<1.75.

30. The optical imaging lens assembly of claim 21, wherein the image-side surface of the sixth lens element is concave in a paraxial region thereof, the image-side surface of the sixth lens element has at least one convex critical point in an off-axial region thereof, a maximum effective radius of the object-side surface of the first lens element is Y11, a maximum effective radius of the image-side surface of the sixth lens element is Y62, a curvature radius of the image-side surface of the sixth lens element is R12, and the following conditions are satisfied:
1.5<Y62/R12<6.0; and
1.6<Y62/Y11<2.4.

31. The optical imaging lens assembly of claim 21, wherein the object-side surface of the first lens element is convex in a paraxial region thereof, and the object-side surface of the first lens element has at least one concave critical point in an off-axial region thereof.

32. The optical imaging lens assembly of claim 21, wherein the third lens element has an image-side surface being concave in a paraxial region thereof, and the fourth lens element has an image-side surface being concave in a paraxial region thereof.

33. An image capturing unit, comprising:
the optical imaging lens assembly of claim 21; and
an image sensor disposed on an image surface of the optical imaging lens assembly.

34. An electronic device, comprising:
the image capturing unit of claim 33.
